(19) United States
(12) Patent Application Publication
(10) Pub. No.: US 2024/0090154 A1
(43) Pub. Date: Mar. 14, 2024

(54) DISTRIBUTED BUILDING AUTOMATION CONTROLLERS

(71) Applicant: PassiveLogic, Inc., Holladay, UT (US)

(72) Inventors: Troy Aaron Harvey, Brighton, UT (US); Jeremy David Fillingim, Salt Lake City, UT (US)

(21) Appl. No.: 18/510,085

(22) Filed: Nov. 15, 2023

Related U.S. Application Data
(63) Continuation-in-part of application No. 17/820,976, filed on Aug. 19, 2022, now Pat. No. 11,856,723.
Application No. 17/820,976 is a continuation of application No. 17/135,212, filed on Dec. 28, 2020, now Pat. No. 11,490,537.

(51) Int. Cl. H05K 7/14; F24F 11/32; F24F 11/49; F24F 11/63; F24F 11/88; G01R 31/55; G05B 13/02; G05B 15/02; G05B 19/048; G05B 23/02; G06F 1/3209; G06F 1/3246; G06F 3/041; G06F 3/0482; G06F 3/04847; G06F 3/147; G06F 8/41; G06F 8/51; G06F 8/53; G06F 8/74; G06F 9/4401; G06F 30/12; G06F 30/13; G06F 30/18; G06Q 30/0283; H02J 3/00; H04B 3/46; H04L 43/50; H04L 67/12; H04L 67/125; H04L 67/75; H04M 3/30; H04W 4/80; H04W 84/00

(52) U.S. Cl. CPC H05K 7/1465; F24F 11/32; F24F 11/49; F24F 11/63; F24F 11/88; G01R 31/55; G05B 13/0265; G05B 15/02; G05B 19/048; G05B 23/0216; G05B 23/0264; G05B 23/0272; G06F 1/3209; G06F 1/3246; G06F 3/04186; G06F 3/0482; G06F 3/04847; G06F 3/147; G06F 8/436; G06F 8/51; G06F 8/53; G06F 8/74; G06F 9/4418; G06F 30/12; G06F 30/13; G06F 30/18; G06Q 30/0283; H02J 3/00; H04B 3/46; H04L 43/50; H04L 67/12; H04L 67/125; H04L 67/75; H04M 3/305; H04W 4/80; H04W 84/00; H05K 7/1468; H05K 7/1477; H05K 7/1481; G06F 30/392

(57) ABSTRACT

Various embodiments relate to a method, apparatus, and machine-readable storage medium including one or more of the following: identifying a chunk of computer code from a larger process to be executed as a distributed computation; creating a job request specifying the chunk of computer code and data on which the chunk of computer code is to operate; selecting a device from a plurality of devices to process the job request; transmitting the job request to the selected device; receiving a job result from the selected device; continuing the larger process based on the job result.

### PRIORITY CLAIM

This application is a continuation-in-part of U.S. patent application Ser. No. 17,820,976, filed Aug. 19, 2022; which is a continuation of U.S. Pat. No. 11,490,537, filed Dec. 28, 2020; which claims priority to U.S. provisional patent application No. 63/070,460, filed Aug. 26, 2020; the entire disclosures of which are hereby incorporated by reference herein for all purposes.

### TECHNICAL FIELD

Various embodiments described herein relate to distributed computation and more particularly, but not exclusivity, distributed computing among on-premise devices utilizing a digital twin.

### BACKGROUND

With the advent of digital twin-based building control, sophisticated simulations and optimization techniques can be used to drive autonomous control. Better results are often driven by more complex computations which, in turn, utilize more system resources such as memory and processing capacity. In many cases, it is easy to quickly outgrow the resources available at an on-premise controller. A straightforward approach to solve this would be to simply perform this processing off-site at a data center with additional resources. This, however, may not be an ideal solution where network connectivity cannot be 100% guaranteed at all times or in installations that are purposely “air-gapped” with no network connectivity.

### SUMMARY

According to the foregoing, there is a need for a system that can perform complex, resource-intensive computations on-premise by installed devices. According to various embodiments, multiple controllers are deployed in an environment that coordinate to distribute work amongst themselves. In this manner, the combined resource pool of these controllers can be utilized to perform much more complex computations, and therefore more sophisticated control, than would otherwise be possible. Furthermore, where these distributed computations involve large data structures, deduplication approaches described herein enable this resource expansion while avoiding placing a large tax on the communications network that would otherwise carry the data structures to each of the controllers for each distributed work package. Various additional technical improvements will be apparent.

Various embodiments described herein relate to a method for performing a distributed computation including one or more of the following: identifying a chunk of computer code from a larger process to be executed as a distributed computation; creating a job request specifying the chunk of computer code and data on which the chunk of computer code is to operate; selecting a device from a plurality of devices to process the job request; transmitting the job request to the selected device; receiving a job result from the selected device; continuing the larger process based on the job result.

Various embodiments described herein relate to a device capable of utilizing a distributed computation method including one or more of the following: a communications interface; a memory storing: code specifying a process to be executed at least in part by the device; and a processor configured to: identify a chunk of the computer code to be executed as a distributed computation, create job request specifying the chunk of computer code and data on which the chunk of computer code is to operate, select a device from a plurality of devices to process the job request, transmit the job request to the selected device, receive a job result from the selected device, and continue the process based on the job result.

Various embodiments described herein relate to a non-transitory machine-readable storage medium encoded with instructions for performing a distributed computation including one or more of the following: instructions for identifying a chunk of computer code from a larger process to be executed as a distributed computation; instructions for creating a job request specifying the chunk of computer code and data on which the chunk of computer code is to operate; instructions for selecting a device from a plurality of devices to process the job request; instructions for transmitting the job request to the selected device; instructions for receiving a job result from the selected device; and instructions for continuing the larger process based on the job result.

Various embodiments are described wherein the job request specifies the chunk of computer code with a function name known to the selected device as being associated with the chunk of computer code.

Various embodiments additionally include receiving a request to execute a group of jobs as a distributed computation, wherein: the group of jobs are associated with the chunk of computer code and respective variations on the data; creating the job request includes creating a plurality of job requests specifying the chunk of computer code and the respective variations on the data; selecting a device includes selecting one or more devices from the plurality of devices to process respective ones of the plurality of job requests; and transmitting the job request includes transmitting the plurality of job requests to respective ones of the one or more selected devices.

Various embodiments are described wherein: receiving a job result includes receiving a plurality of job results that are fewer than the plurality of job requests, and continuing the larger process based on the job result includes determining, based on a policy for the group of jobs, that the plurality of job results are sufficient to continue the larger process.

Various embodiments are described wherein: receiving a job result includes receiving a plurality of job results, and continuing the larger process based on the job result includes: determining, based on a policy for the group of jobs, a time limit, and when the time limit is reached, continuing the larger process with the plurality of job results received before the time limit was reached.

Various embodiments are described wherein the data includes a delta value describing a change to data already known to the selected device.

Various embodiments are described herein the data already known to the selected device includes a digital twin of a real-world system.

### BRIEF DESCRIPTION OF THE DRAWINGS

In order to better understand various example embodiments, reference is made to the accompanying drawings, wherein:

FIG. 1 illustrates an example system for implementation of various embodiments;

FIG. 2 illustrates an example system for implementing and deploying a controller device;

FIG. 3 illustrates an example recipe;

FIG. 4 illustrates an example architecture of a distributed work engine;

FIG. 5 illustrates an example hardware device for implementing a controller;

FIG. 6 illustrates an example data arrangement for implementing a pending job list;

FIG. 7 illustrates an example of a job request message;

FIG. 8 illustrates an example of a job response message;

FIG. 9 illustrates an example method for handling internal distributed work requests and distributing associated job requests;

FIG. 10 illustrates an example method for receiving and enqueuing a job request;

FIG. 11 illustrates an example method for executing and responding to a distributed job request;

FIG. 12 illustrates an example method for processing a job result; and

FIG. 13 illustrates an example method for auditing a pending job list.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

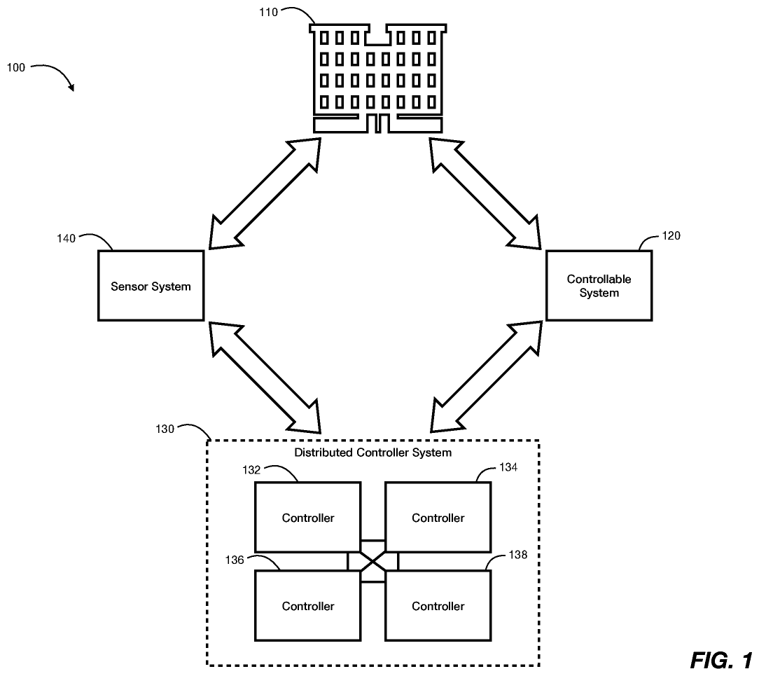

FIG. 1 illustrates an example system 100 for implementation of various embodiments. As shown, the system 100 may include an environment 110, some aspect of which is affected by a controllable system 120. The behavior of the controllable system 120 is, in turn, controlled by a distributed controller system 130. To obtain information useful in making control decisions, the distributed controller system 130 receives data from a sensor system 140 which, in turn, generates its data based on observations from the environment 110.

According to one specific example, system 100 may describe a heating, ventilation, and air conditioning (HVAC) application. As such the environment 110 may be a building whose temperature is to be controlled by the controllable system 120. The controllable system 120 may be the HVAC system itself, which may be controllable to distribute warm or cool air throughout the building 110. Thus, the controllable system 120 may include HVAC equipment such as pumps, boilers, radiators, chillers, fans, vents, etc. The sensor system 140 may include a set of temperature sensors distributed throughout the building 110 to collect and report temperature values.

While various embodiments disclosed herein will be described in the context of such an HVAC application, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied other applications outside the context of controlled systems. Various modifications to adapt the teachings and embodiments to use in such other applications will be apparent.

As shown, the distributed controller system 130 includes four controllers 132, 134, 136, 138 in communication with one another. The controllers 132, 134, 136, 138 may be located within the environment 110, at another location (such as another environment similar to the environment 110 or in a cloud data center), or some combination thereof. Each controller 132, 134, 136, 138 may be connected to one or more field devices, such as individual devices of the controllable system 120 or sensor system 140. Such connection may be direct or indirect (e.g., via one or more intermediate devices such, as in the case of a communications network), wired or wireless, or any other type of connection that would enable communication between devices. In some embodiments, each controller 132, 134, 136, 138 may be connected to those devices of the controllable system 120 or sensor system 140 that are physically most proximate to that respective controller 132, 134, 136, 138. For example, where the environment 110 is a building with four floors, the controllers 132, 134, 136, 138 may be installed one on each such floor and then connected to the devices of the controllable system 120 or sensor system 140 physically located on the same floor. Alternatively, devices of the controllable system 120 may be distributed amongst controllers 132, 134, 136, 138 via criteria other than physical proximity, such as demand of the devices on each controller 132, 134, 136, 138.

The controllers 132, 134, 136, 138 may be identical to each other or may employ different hardware or software. For example, two controllers 132, 134 may be full featured controllers while the other two controllers 136, 138 may be satellite controllers with limited capabilities with respect to the full featured controllers. As another example, one or more of the controllers 132, 134, 136, 138 may be specialized in one or more respects, deployed to work on only a subset of tasks associated with controlling the controllable system 120. As such, the controllers 132, 134, 136, 138 may implement partial or full redundancy of functionality or may divide functionality among themselves (either by pre-installation component design or by post-installation coordination or agreement) to achieve a fully functional distributed controller system 130. While the teachings and embodiments disclosed herein will be described with respect to fully-redundant, fully-featured controllers 132, 134, 136, 138 (unless otherwise noted), modifications for applications of the teachings and embodiments for application to such alternative controller 132, 134, 136, 138 arrangements will be apparent. It will also be apparent that other embodiments may include a greater or fewer number of controllers. In some such embodiments, the system 100 may include only a single controller, rather than multiple controllers cooperating in a distributed manner. Various modifications in such alternative embodiments will be apparent.

Various methods for implementing a distributed controller system 130 may be employed for coordinating the functions of the controllers 132, 134, 136, 138. For example, the controllers 132, 134, 136, 138 may coordinate to elect a single controller 132, 134, 136, 138 to take the role of “leader” controller, while the remaining controllers 132, 134, 136, 138 become “follower” controllers. In such an arrangement, each follower controller may perform some limited functionality, such as receiving sensor data from those devices in the sensor system 140 attached to that follower controller, committing such sensor data to a database available to the other controllers 132, 134, 136, 138, ensuring proper connections and operation of devices of the controllable system 120 attached to that follower controller, performing fault detection for one or more field devices, or calculating derived “sensor” or otherwise predicting data for areas or components where direct observation (e.g., via a physical sensor device) is not possible.

Meanwhile, the elected leader controller may be responsible for additional functionality such as, for example, training machine learning models, running simulations, and making control decisions for the controllable system 120. In some embodiments, the elected leader controller may rely on the remaining controllers 132, 134, 136, 138 to assist in the performance of these tasks by distributing work among the follower controllers according to various distributed work paradigms that may be employed. For example, the leader controller may break a task to be performed into multiple smaller steps or work packages, transmit the steps or work packages to the follower controllers for performance, receive the sub-results of the steps or work packages back when the work is completed, and use the sub-results to arrive at an ultimate result (e.g., a further trained model, a completed simulation or set of simulations, or a control decision). With regard to control decisions or other actions involving communication with devices of the controllable system 120 or the sensor system 140, the leader controller may determine to which of the controllers 132, 134, 136, 138 the device is connected and send the control instruction to that controller 132, 134, 136, 138, which in turn passes the control instruction on to the intended device.

It will be understood that FIG. 1 may represent a simplification in some respects. For example, in some embodiments, one or more devices may be both a controllable device (belonging to the controllable system 120) and a sensor device (belonging to the sensor system 140). For example, a controllable pump may have an integrated sensor that reports an observed pressure back to the distributed controller system 130. In some embodiments, there may be multiple controllable systems 120, multiple sensor systems 140, or other systems (not shown) involved in implementing the overall system 100, each of which may or may not be in communication with the distributed controller system 130. For example, the distributed controller system 130 may control both an HVAC system and a lighting system, which may be implemented as two independent controllable systems 120. As another example, the distributed controller system 130 may obtain sensor data from both a set of sensors the distributed controller system 130 manages as well as a set of sensors managed by a third party service (e.g., as may be made available through an API or other network-based service) and, as such, there may be multiple independent sensor systems 140 that inform the operation of the distributed controller system 130. In some embodiments, the distributed controller system 130 may manage controllable systems 120 for multiple environments 110 (e.g., the HVAC systems for two or more separate buildings) or may be in communication with other distributed controller systems 130 associated with implementations of systems similar to system 100 for other environments 110 (e.g., to extend the processing capacity through distribution of work to additional controllers, to execute multi-building control actions, or to gather information from other environments such as predicted power usage). Thus, where the environment 110 is a building, one or more distributed controller systems 130 may implement not only a “smart building” but a “smart city” of multiple buildings coordinating their operations. Various modifications for replicating, extending, or otherwise adapting the teachings herein across additional environments, controllable systems, distributed controller systems, or sensor systems will be apparent.

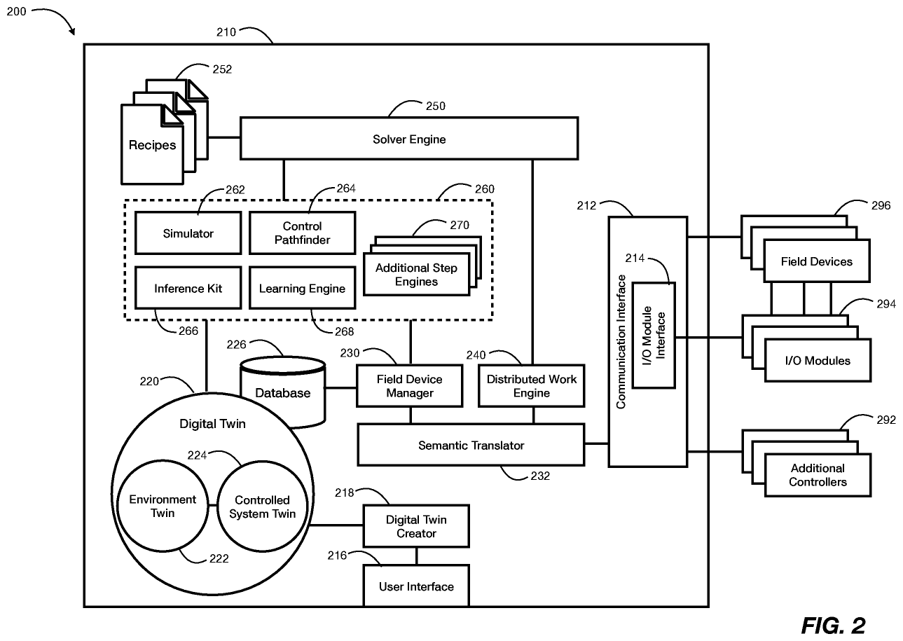

FIG. 2 illustrates an example system 200 for implementing and deploying a controller device 210. The controller device 210 may correspond to one of the controllers 132, 134, 136, 138 of the example system 100 and, as such, may communicate with additional controllers 292 (which may correspond to the remaining controllers 132, 134, 136, 138) to implement a distributed controller system such as the distributed controller system 130. In other embodiments, where only a single controller 210 is used, the additional controllers 292 may not be present. In some embodiments, the controller 210 may be or include a building automation system (BAS) or building management system (BMS).

The controller 210 also communicates with multiple field devices 296. These field devices 296 may correspond to one or more devices belonging to the controllable system 120 or sensor system 140 of the example system 100. Similarly, other field devices 296 may communicate with the additional controllers 292. As such, the field devices 296 may include devices that may be controlled to affect some state of an environment (e.g., HVAC equipment that cooperate to manage a building temperature) or sensor devices that report back information about the environment (e.g., temperature sensors deployed among the different environmental zones of the building).

As noted above, virtually any connection medium (or combination of media) may be used to enable communication between the controller 210 and the additional controllers 292 or field devices 296, including wired, wireless, direct, or indirect (i.e., through one or more intermediary devices, such as in a communications network) connections. As used herein, the term “connected” as used between two devices will be understood to encompass any form of communication capability between those devices. To enable such connections, the controller 210 includes a communications interface 212. As will be explained in greater detail below, the communication interface 212 may include virtually any hardware for enabling connections with additional controllers 292 or field devices 296, such as an Ethernet network interface card (NIC), WiFi NIC, or USB connection.

In some embodiments, one or more connections to other devices may be supported by one or more I/O modules 294. The I/O modules 294 may provide further hardware or software used in controlling or otherwise communicating with field devices 296 having specific protocols or other particulars for such communication to occur. For example, where a field device 296 includes a motor to be controlled, an I/O module 294 having components such as a motor control block, motor drivers, pulse width modulation (PWM) control, or other components relevant to motor control may be used to connect that field device 296 to the controller 210. Various additional components for inclusion in different I/O modules 294 for control of different particular field devices 296 will be apparent. Additional features, such as current or voltage monitoring or overcurrent protection may also be incorporated into the I/O modules 294. To enable communication with the I/O modules 294, the communication interface 212 may include an I/O module interface 214. In various embodiments, the I/O module interface 214 may be a set of electrical contacts for contact with complementary pins of the I/O modules 294. A communication protocol, such as USB, may be implemented over such contacts and pins to enable passing of information between the controller 210 and I/O modules 294. In other embodiments, the I/O module interface 314 may include the same interfaces previously described with respect to the communication interface. In various alternative embodiments, on the other hand, some or all of these more particular components may be incorporated into the controller 210 itself, and some or all of the I/O modules 294 may be omitted from the system 200. Various additional techniques for implementing an I/O module 294 according to various embodiments, may be described in U.S. Pat. Nos. 11,229,138; and 11,706,891, the entire disclosures of which are hereby incorporated herein by reference.

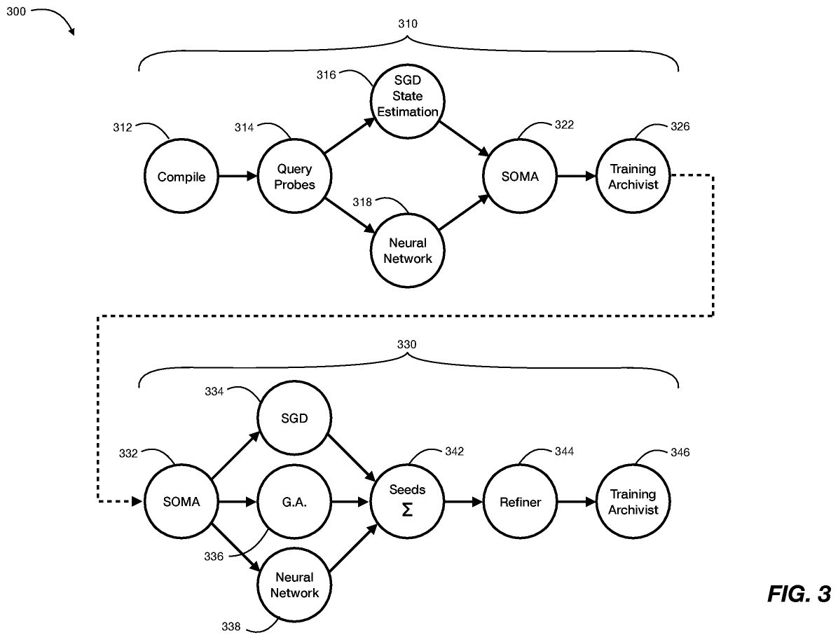

According to various embodiments, the controller 210 utilizes a digital twin 220 that models at least a portion of the system it controls and may be stored in a database 226 along with other data. As shown, the digital twin 220 includes an environment twin 222 that models the environment whose state is being controlled (e.g., a building) and a controlled system twin 224 that models the system that the controller 210 controls (e.g., an HVAC equipment system). A digital twin 220 may be any data structure that models a real-life object, device, system, or other entity. Examples of a digital twin 220 useful for various embodiments will be described in greater detail below with reference to FIG. 3. While various embodiments will be described with reference to a particular set of heterogeneous and omnidirectional neural network digital twins, it will be apparent that the various techniques and embodiments described herein may be adapted to other types of digital twins such as building information models, equipment simulators, etc., unless otherwise noted. Further, while the environment twin 222 and controlled system twin 224 are shown as separate structures, in various embodiments, these twins 222, 224 may be more fully integrated as a single digital twin 220. In some embodiments, additional systems, entities, devices, processes, or objects may be modeled and included as part of the digital twin 220.

In various embodiments, a user may create or modify the digital twin 220. In some such embodiments, the controller 210 may include a user interface 216 through which the user accesses a digital twin creator 218 to create or modify the digital twin 220. For example, the user interface 216 may include a display, a touchscreen, a keyboard, a mouse, or any device capable of performing input or output functions for a user. In some embodiments, the user interface 216 may instead or additionally allow a user to use another device for such input or output functions, such as connecting a separate tablet, mobile phone, or other device for interacting with the controller 210. Such a connection to a separate device may be direct or indirect, including via a network such as the internet.

The digital twin creator 218 may provide a toolkit for the user to create digital twins 220 or portions thereof. For example, the digital twin creator 218 may include a tool for defining the walls, doors, windows, floors, ventilation layout, and other aspects of a building construction to create the environment twin 222. The tool may allow for definition of properties useful in defining a digital twin 220 (e.g., for running a physics simulation using the digital twin 220) such as, for example, the materials, dimensions, or thermal characteristics of elements such as walls and windows. Such a tool may resemble a computer-aided drafting (CAD) environment in many respects. According to various embodiments, unlike typical CAD tools, the digital twin creator 218 may digest the defined building structure into a digital twin 220 model that may be computable, trainable, inferenceable, and queryable, as will be described in greater detail below.

In addition or alternative to building structure, the digital twin creator 218 may provide a toolkit for defining virtually any system that may be modeled by the digital twin 220. For example, for creating the controlled system twin 224, the digital twin creator 218 may provide a drag-and-drop interface where avatars for various HVAC equipment (e.g., boilers, pumps, valves, tanks, etc.) may be placed and connected to each other, forming a diagram of a system (or a group of systems) that reflect the real world controllable system 120. In some embodiments, the digital twin creator 218 may drill even further down into definition of twin elements by, for example, allowing the user to define individual pieces of equipment (along with their behaviors and properties) that may be used in the definition of systems. As such, the digital twin creator 218 provides for a composable twin, where avatars individual elements may be “clicked” together to model higher order equipment and systems, which may then be further “clicked” together with other elements. The digital twin creator 218 may create a digital twin 220 representation in memory matching the graphical diagram created by the user or using behaviors and properties defined by the user.

In other embodiments, the digital twin 220 may be created by another device (e.g., by a server providing a web- or other software-as-a-service (SaaS) interface for the user to create the digital twin 220, or by a device of the user running such software locally) and later downloaded to or otherwise synced to the controller 210 (e.g., via the Internet or via an intermediate device such as a mobile device that carries the digital twin on-site and loads it wirelessly onto the controller 210). Such alternative device may utilize software tools similar to those described with respect to the digital twin creator 218. In other embodiments, the digital twin 220 may be created automatically by the controller 210 through observation of the systems it controls or is otherwise in communication with. In some embodiments a combination of such techniques may be employed to produce an accurate digital twin—a first user may initially create a digital twin 220 using a SaaS service, the digital twin 220 may be downloaded to the controller 210 where a second user further refines or extends the digital twin 220 using the digital twin creator 218, and the controller 210 in operation may adjust the digital twin 220 as needed to better reflect the real observations from the systems it communicates with. Various additional techniques for defining, digesting, compiling, and utilizing a digital twin 220 according to some embodiments may be described in U.S. Pat. Nos. 10,708,078; and 10,845,771; and U.S. patent application publication numbers 2021/0383200; 2021/0383235; and 2022/0215264, the entire disclosures of which are hereby incorporated herein by reference.

In addition to storing the digital twin 220, the database 226 may store additional information that is used by the controller 210 to perform its functions. For example, the database 226 may hold tables that store sensor data collected from field devices 296 or control actions that should be issued to field devices 296. Various additional or alternative information for storage in the database 226 will be apparent. In various embodiments, the database 226 implements database replication techniques to ensure that the database 226 content is made available to the additional controllers 292. As such, changes that the controller 210 makes to the database 226 content (including the digital twin 220) may be made available to each of the controllers 292, while database changes made by the additional controllers 292 are similarly made available in the database 226 of the controller 210 as well as the other additional controllers 292.

A field device manager 230 may be responsible for initiating and processing communications with field devices 296, whether via I/O modules 294 or not. As such the field device manager 230 may implement multiple functions. For sensor management, the device manager 230 may receive (via the communication interface 212 and semantic translator 232) reports of sensed data. The field device manager 230 may then process these reports and place the sensed data in the database 226 such that it is available to the other components of the controller 210. In managing sensor devices, the field device manager 230 may be configured to initiate communications with the sensor devices to, for example, establish a reporting schedule for the sensor devices and, where the sensor devices form a network for enabling such communications, the network paths that each sensor device will use for these communications. In some embodiments, the field device manager 230 may receive (e.g., as part of sensor device reports) information about the sensor health and then use this information to adjust reporting schedule or the network topology. For example, where a sensor device reports low battery or low power income, the controller 210 may instruct that sensor device to report less frequently or to move to a leaf node of the network topology so that its power is not used to perform the function of routing messages for other sensors with a better power state. Various other techniques for managing a group or swarm of sensor devices will be apparent.

The field device manager 230 may also be responsible for managing and verify the connections of field devices 296 to the I/O modules 294. For example, configuration data stored in the digital twin 220 or elsewhere in the database 226 may indicate that a particular field device 296 is expected to be connected to a particular I/O module 294 having a particular set of supporting components, that the particular I/O module 294 is expected to be connected to a particular I/O module interface 214, and that communications through the particular I/O module 294 are expected to occur according to a particular set of protocols. The field device manager 230 may test (e.g., by sending one or more test communications) that the particular field device 296 is actually set up according to these configurations (e.g., if communications are successful or not) and then take remedial action if there is an installation problem. In some cases, the field device manager 230 may simply update the configuration information if doing so will solve the incorrect installation (e.g. the I/O module 294 is connected to a different I/O module interface 214 but is otherwise working, the I/O module 294 is configured to communicate according to a different protocol). In other cases, the field device manager 230 may prompt a user that these is an issue with the connection and ask for the user to take remedial action (e.g., reconfigure settings at the controller 210 or physically relocate, replace, or otherwise reinstall an I/O module 294, connection wires, or the field device 296). As such, the field device manager 230 in some embodiments provides a software toolset for the user via the user interface 216, a web portal, or elsewhere. In some embodiments, such a user interface 216 may be a graphical representation of the controller 210, I/O modules 294, and field device 296 connections thereto that allows the user to see how these devices are expected by the controller 210 to be installed. In some embodiments, the toolset may also allow the user to reconfigure these expectations rather than physically changing the system of devices (e.g., by dragging an I/O module graphic to a different connection graphic, or by changing a connection type for one or more wiring terminal graphics of an I/O module graphic).

In some embodiments, in addition to the verification of I/O module 294 connections, the field device manager 230 may perform a fuller commissioning procedure. For example, the field device manager 230 may perform a series of tests on the field devices 296 that are connected to the controller 210 or on the full set of field devices 296 in the controllable system 120 or the sensor system 140 (particularly where the controller 210 has been elected as a leader controller). Accordingly, in some such embodiments, the field device manager 230 may communicate with the field devices 296 via the communication interface 212 to perform tests to verify that installation and behavior is as expected (e.g., as expected from simulations run against the digital twin 220 or from other configurations stored in the database 226 or otherwise available to the controller 210). Where the field device manager 230 drives testing of field devices 296 attached instead to one or more additional controllers 292, the testing may include communication with the additional controllers 292 (e.g., through use of the distributed work engine 240 or directly through the communications interface 212), such as test messages that the additional controllers 292 route to their connected field devices 296 or instructions for the additional controllers 292 to perform testing themselves and report results thereof.

In some embodiments, the testing performed by the field device manager 230 may be defined in a series of scripts, preprogrammed algorithms, or driven by artificial intelligence (examples of which will be explained below). Such tests may be very simple (e.g., “can a signal be read on a wire,” or “does the device respond to a simple ping message”), device specific (e.g., “is the device reporting errors according to its own testing,” “is the device reporting meaningful data,” “does the device successfully perform a test associated with its device type”), driven by the digital twin 220 (“does this device report expected data or performance when this other equipment is controlled in this way,” “when the device is controlled this way, do other devices report expected data”), at a higher system level (“does this zone of the building operate as expected,” “do these two devices work together without error”), or may have any other characteristics for verifying proper installation and functioning of a number of devices both individually and as part of higher order systems.

In some embodiments, a user may be able to define (e.g., via the user interface 216) at least some of the commissioning tests to be performed. In some embodiments, the field device manager 230 presents a graphical user interface (GUI) (e.g., via the user interface 216) for giving a user insight into the commissioning procedures of the field device manager 230. Such a GUI may provide an interface for selecting or otherwise defining testing procedures to be performed, a button or other selector for allowing a user to instruct the field device manager 230 to begin a commissioning process, an interface showing the status of an ongoing commissioning process, or a report of a completed commissioning process along with identification of which field devices 296 passed or failed commissioning, recommendations for fixing failures, or other useful statistics.

In some embodiments, the data generated by a commissioning process may be useful to further train the digital twin 220. For example, if activating a heating radiator does not cool a room as much as expected, there may be a draft or open window in the room that was not originally accounted for that can now be trained intro the digital twin 220 for improved performance. As such, in some embodiments, the field device manager 230 may log the commissioning data in a form useful for the learning engine 268 to train the digital twin 220, as will be explained in greater detail below.

In some embodiments, the field device manager 230 may also play a role in networking. For example, the field device manager 230 may monitor the health of the network formed between the controller 210 and the additional controllers 292 by, for example, periodically initiating test packets to be sent among the additional controllers 292 and reported back, thereby identifying when one or more additional controllers 292 are no longer reachable due to, e.g., a device malfunction, a device being turned off, or a network link going down. In a case where one of the additional controllers 292 had been elected leader, the field device manager 230 may call for a new leader election among the remaining reachable additional controllers 292 and then proceed to participate in the election according to any of various possible techniques.

With respect to runtime control of the field devices 296, while other components (such as the control pathfinder 264) may decide what control actions are to be taken and make them available to other components (e.g., by writing the desired actions to the database 226), the field device manager 230 may be responsible for issuing the commands to the field devices 296 that cause the desired action to occur. In some embodiments, where the controller 210 is elected leader controller, the field device manager 230 may issue commands not only to the field devices 296 connected to the controller 210 but also to the additional controllers 292. In other embodiments where the database 226 is available to multiple controllers 210, 292 (e.g., through database replication techniques, by allowing the additional controllers 292 to query the database 226 of the controller 210, or by making the database 226 available on a different accessible server) the respective field device managers 230 or analogous components of the additional controllers 292 may similarly notice updates to the desired control actions and issue commands to their respective attached field devices 296 to effect the desired controls. Various additional techniques for implementing a field device manager 230 according to various embodiments may be described in U.S. Pat. Nos. 11,477,905; 11,596,079; and U.S. patent application publication numbers 2022/0067226; 2022/0067227; 2022/0067230; and 2022/0070293, the entire disclosures of which are hereby incorporated herein by reference.

Various embodiments utilize a higher order language to direct operations internal to the controller 210 and additional controllers 292. As an example, while field devices 296 may be controlled or otherwise communicate according to various diverse semantics and protocols (e.g., BACnet, Modbus, Wirepas, Pulse-Width Modulation, Frequency Modulation, 1-Wire, Bluetooth Low Energy Mesh, Ethernet, WiFi, 24VAC, Voltage signal, Current signal, Resistance signal, the higher order language itself, etc.), desired actions identified by the control pathfinder 264, written to the database 226, or issued by the field device manager 230 may be agnostic to these particular differences. As another example, while the actions that the field devices 296 can perform may be differentiated based on the characteristics of a device (a pump can be instructed to pump fluid, a fan can be instructed to spin), these actions may be abstracted (or semantically raised) into the same action (either of these devices may be instructed to cause quanta to move). Thus, when a BACnet pump is to be instructed to begin pumping fluid, rather than issuing a specific BACNet command that will activate that pump or issuing an instruction for the pump to begin pumping, the field device manager 230 may issue a command that the particular “transport” field device 296 begin to move quanta from its input to its output. Such a higher order language may be reflective of the high order at which the digital twin 220 is defined, as will be explained in greater detail below.

While some field devices 296 may natively understand the higher order language, others may still require communication according to their own native protocols. A semantic translator 232 may thus be responsible for translating higher order language communications received from the field device manager 230 or distributed work engine 240 into the appropriate lower level, protocol specific messages that will be sent via the communication interface 212. So, where the field device manager 230 issues a command for a particular transport field device 296 to begin moving quanta, the semantic translator 232 may semantically lower this command to a command for a pump to begin pumping fluid (or for a fan to begin spinning, etc., depending on the specifics of the device as may be defined in the digital twin 220) and then semantically translate this command to a BACnet message (or Modbus, etc., depending on the specifics of the device as may be defined in the digital twin 220) that will accomplish the lowered action. The semantic translator 232 may then transmit the fully-formed message to the appropriate recipient device via the communications interface 212. Thus, while the digital twin 220 and other internal components of the controller 210, may operate according to a semantically-raised language (which may be driven by a semantic ontology used in the digital twin 220), the digital twin 220 may additionally store information for the various field devices 296 useful in semantically lowering and translating this language to enable effective communication with the field devices 296. In various embodiments, the semantic translator 232 may work in the opposite direction as well, translating and raising incoming messages from the field devices 296, such that they may be interpreted and acted on according to the semantically raised language of the controller 210. Various techniques for implementing a semantic translator 232, a digital twin 220 ontology, or an internal semantically-raised language according to some embodiments may be disclosed in U.S. patent application publication numbers 2022/0066754; and 2022/0066761, the entire disclosures of which are incorporated herein by reference.

As shown, the controller 210 includes a distributed work engine 240 for guiding the distributed operation of the controller 210 with additional controllers 292. As such, the distributed work engine 240 may receive computation steps (e.g., from the solver engine 250) to be outsourced to other controllers 292, transmit the work (via the semantic translator 232 or communication interface 292) to the additional controllers 292, receive work results back, and pass them back to the solver engine 250. Such a workflow may be used when, for example, the controller 210 has been elected as a leader controller. The distributed work engine 240 may also implement the other side by receiving work requests from one or more additional controllers 292, passing the work requests to the solver engine 250 or directly to a step engine 260, receiving the result of the work, and transmitting the result back to the requesting controller 292. Such a workflow may be used when, for example, the controller 210 has been not elected as a leader controller and is, instead, a follower controller. In various alternative embodiments, the controller 210 may both issue work requests to other controllers 292 and execute work requests received from additional controllers 292, regardless of status as a leader or follower (if any). The distributed work engine 240 may perform additional functionality associated with managing a distributed compute system such as, for example, performing a leader election process, selecting particular ones of the additional controllers 292 to receive particular work requests, receiving load metrics or otherwise assessing compute health/capacity of the additional controllers 292, performing load balancing among the additional controllers 292, deciding when to resend or reassign previously issued work requests, deciding when to time out previously issued work requests (too much time has elapsed, a sufficient number of other responses have been received, etc.) and instruct the solver engine 250 to move on with the next steps of a computation. Various additional techniques for implementing a distributed work engine 240 according to some embodiments may be described in U.S. Pat. No. 11,490,537, the entire disclosure of which is hereby incorporated herein by reference.

A solver engine 250 may be responsible for driving many, if not all, of the higher order functions of the controller 210 such as, for example, running simulations, deciding on control actions to be taken, causing the digital twin 220 to learn from observations, etc. To effect such actions, the solver engine 250 may execute various recipes 252 (which may be stored in the database 226 or elsewhere) that define a sequence of steps to be performed by separate step engines 260. Accordingly, the solver engine 250 may identify a recipe to be executed (e.g., based on manual selection of a recipe 252 for execution by a user, invocation of a recipe 252 by step engine 260, identification by the step of another recipe 252 under execution, a scheduled time for a recipe 252, a timer elapsing since the past execution of the recipe 252, or the occurrence of some trigger event associated with the recipe 252). The solver engine 250 may then begin to “walk through” or otherwise execute the steps of the recipe 252, identifying an appropriate step engine 260 to perform the step, issuing the step to that step engine 260, receiving the result after the step engine 260 has completed its work, and then move on to the next step of the recipe 252. In some embodiments, the solver engine 250 may itself be adapted to perform some steps. The solver engine 250 may then iterate on this process until it reaches the end of the recipe 252.

In some cases, the solver engine 250 may decide that one or more steps of a recipe 252 are to be outsourced to another controller 292. For example, the recipe 252 itself may specify that a step is to be performed by another controller 292, the solver engine 250 may determine that local processing capacity is not sufficient to perform a step, or the solver engine may encounter multiple parallel steps in a recipe 252 and decide to perform only one or a subset locally while outsourcing the rest.

The step engines 260 may include a number of varying functions that can be relied on by the recipes 252 and solver engine 250 to perform various steps of a larger task. As shown, the step engines 260 include a simulator 262, a control pathfinder 264, and inference kit 266, a learning engine 268, and one or more additional step engines 270. It will be apparent that fewer, additional, or different step engines 270 may be included depending on the functions to be performed by the controller 210 (e.g., as may be defined in the recipes 252) and as appropriate to adapting the controller 210 for use in different applications.

The simulator 262 may be configured to simulate the behavior of the system 100 into the future or under alternative/hypothesis conditions. To accomplish such a simulation, the simulator 262 may execute a sequence of time steps (e.g., simulating the state of the digital twin 220 a minute into the future at a time) until the future time is reached and state can be read from the digital twin 220. For example, to simulate the temperature of a zone one hour into the future, the simulator 262 may propagate heat from all heat sources through the digital twin 220 one minute at a time, sixty times, and then read the temperature of the zone from the digital twin 220. The use of the digital twin 220 to perform such simulations will be explained in greater detail below. In various embodiments, the simulator 262 may actually encompass multiple more specific simulator step engines. For example, the simulator 262 may include separate simulators for simulating state of the building, operating of equipment, occupancy of different zones of the building, and the impact of weather or other external factors on the state of the system 100. The simulator 262 (or other step engines 260) may make use of the digital twin in different manners. In some cases, the simulator 262 may retrieve a precompiled (e.g., at the time of initial digital twin creation) digital twin 220, place it in memory, populate relevant data into it, and use the data that is produced as simulation output. In other cases, the simulator 262 may alter portions of the digital twin 220 description at the time of simulation (e.g., adding or removing equipment, or changing equipment parameters), compile the digital twin at that point in time, place the newly-compiled twin in memory, and then run its simulation. Thus, the digital twin 220 may include both a data description of the systems being modeled as well as compiled and functional versions of that data description.

The control pathfinder 264 may be configured to identify, using the digital twin 220, one or more control actions to be performed be the field devices 296 to reach a desired state. For example, the control pathfinder 264 may analyze multiple possible candidate control schemes against the digital twin 220 to determine which candidate control scheme best produces the desired state in the digital twin 220 and then write the control actions from that scheme to the database 226 for the field device manager 230 to act on. In some embodiments, the control pathfinder 264 may leverage the simulator 262 to perform its task (and likewise, step engines 260 may in some embodiments generally invoke each other when useful to the performance of their task).

In other embodiments, the control pathfinder 264 may utilize auto-differentiation and gradient descent to identify an appropriate control scheme to reach a desired state in the digital twin 220. As will be explained in greater detail below, through auto-differentiation, the digital twin 220 may be established as omnidirectional; that is, while activation functions may be defined or learned in a forward direction, their partial derivatives may be used to define “activation functions” in the reverse direction, thereby enabling traversal of the digital twin 220 in any direction and along any path desired. When paired with differentiable programming to define the digital twin 220 (particularly, its activation functions), such partial derivatives may be made available in the digital twin 220 with little-to-no additional compute cost. From here, the control pathfinder 264 may generate a cost function on the digital twin 220 that relates a set of input variables (e.g., possible control variables) to a cost—the distance between the predicted state values and the desired state values. The control pathfinder 264 may then employ gradient descent to identify a control scheme likely to produce the desired state in the environment 110 (or a state acceptably close to the desired state).

Various additional, alternative, or modified methods may be used by the control pathfinder 264 to locate a control path. For example, in some embodiments, the control pathfinder 264 may employ multiple gradient descent agents (e.g., as a Self -Organizing Migrating Algorithm or SOMA) to improve the likelihood of locating a global minimum of the cost function, rather than a local minimum representing a sub-optimal solution control scheme. In some embodiments, a simpler neural network trained against the digital twin 220 for a reduced problem may be used by the control pathfinder 264 to find a control scheme quickly which is then tested and refined against the digital twin 220 or written directly to the database so that the field devices 296 may be controlled immediately. In some embodiments, the control pathfinder 264 may employ more than one of these and other approaches in an ensemble or adversarial approach to find optimal control schemes. Various additional techniques that may be used in implementing a simulator 262, control pathfinder 264, other step engines 260, or other aspects of the controller 210 according to some embodiments may be described in U.S. Pat. Nos. 10,705,492; 10,921,760; U.S. patent application publication numbers 2021/0381712; 2021/0382445; 2021/0383042; and 2021/0383219, the entire disclosures of which are hereby incorporated herein by reference.

The inference kit 266 may be configured to draw information from the digital twin 220 for use in driving decisions. As such, the inference kit 266 may enable reading of values from the digital twin 220 and transformation of such values into derived properties and other values (e.g., reading heat and humidity values and sending them through a transformation to produce a comfort value). In various embodiments, the inference kit 266 may provide more advanced inferencing such as performing sensor fusion and defining “virtual sensors” to enable simulation of additional state values at locations where there are not sensors in the real world system 100 from which to draw information. Various techniques for implementing an inference kit 266 according to some embodiments may be disclosed in U.S. patent application publication number 2021/0383236, the entire disclosure of which is hereby incorporated herein by reference.

The learning engine 268 may be configured to train machine learning models for the benefit of the controller 210. For example, in various embodiments, the digital twin 220 itself is trainable. As such, the learning engine 268 may periodically use one or more training examples and machine learning approaches (such as supervised learning and gradient descent) to train the digital twin's 220 activation functions to better model the observed real world system. Such training examples may be drawn from the database 226 (e.g., from sensor data placed there by the field device manager 230 or additional controllers 292). In some embodiments, the learning engine 268 may train additional neural networks, deep learning networks, or other machine learning models based on the simulations (e.g., as may be run by the simulator 262). As such, the learning engine 268 may include a training archivist that captures simulated cases during execution of a recipe 252 and stores them as training examples in the database 226. The learning engine 268 may later used these training examples to train these simple models for later use. Thus, in various embodiments, the learning engine 268 trains the digital twin 220 based on real world observed data and then trains simple models based on the operation of the digital twin 220. Various additional techniques for implementing a learning engine 268 according to some embodiments may be disclosed in U.S. patent application publication number 2021/0383041, the entire disclosure of which is hereby incorporated by reference herein.

As noted, the step engines 260 may include additional step engines 270 as appropriate to the recipes 252 and application of the controller 210. For example, the additional step engines 270 may include an ontological reasoner (which may use various techniques to simplify the digital twin 220 to only those portions relevant to a particular task, thereby reducing processing resources needed), an occupant process (which may take into account occupant comfort needs or desires to guide the determination of a desired state in a system), a weather process (which may make or otherwise obtain weather forecasts), and other engines. Various additional step engines 270 that may be useful will be apparent. Various additional techniques for implementing such additional step engines 270 according to some embodiments may be described in in U.S. Pat. Nos. 10,969,133; and 11,553,618, the entire disclosures of which are hereby incorporated herein by reference.

It will be apparent that, while particular components are shown connected to one another, this may be a simplification in some regards. For example, components that are not shown as connected may nonetheless interact. For example, the user interface 216 may provide a user with some access to the recipes 252 or field device manage 230. Furthermore, in various embodiments, additional components may be included and some illustrated components may be omitted. In various embodiments, various components may be implemented in hardware, software, or a combination thereof. For example, the communications interface 212 may be a combination of communications protocol software, wired terminals, a radio transmitter/receiver, and other electronics supporting the functions thereof. As another example, the solver engine 250 and step engines 260 may be implemented as software running on a processor (not shown) of the controller 210, while the digital twin 220 may be a data structure stored in the database 226 which, in turn, may include memory chips and software for managing database organization and access. Various other implementation details will be apparent and various techniques for implementing a controller 210 and various components thereof according to some embodiments may be described in U.S. patent application publication numbers 2022/0066432; 2022/0066722; U.S. provisional patent applications 62/518,497; 62/704,976; and 63/070,460 the entire disclosures of which are hereby incorporated herein by reference.

It will be further apparent that various techniques described herein may be utilized in contexts outside of controller devices. For example, various techniques may be adapted to project planning tools, report generation, reporting dashboards, simulation software, modeling software, computer aided drafting (CAD) tools, predictive maintenance, performance optimization tools, or other applications. Various modifications for adaptation of such techniques to other applications and domains will be apparent.

FIG. 3 illustrates an example recipe 300. This recipe 300 may correspond to one of the recipes 252 of the controller 212 and, as such, may be executed by a solver engine 250 of the controller 210, distributed to one or more other controllers 292 via the distributed work engine 240, or some combination thereof. It will be apparent that the recipe 300 as illustrated may be a simplification and that recipes may take a form in memory other than a graph structure. According to some embodiments, the recipe 300 is embodied in computer code stored in memory. In some embodiments, the recipe 300 is embodied as Swift code that may be stored in pre-compiled form or may be compiled at the time it is to be executed. To define when particular steps or other “chunks” of code may be outsourced, portions of the Swift code may conform to a Swift protocol that identifies that chunk of code as being capable of distribution to other devices. In other embodiments, the recipe 300 may be stored as a script that is interpreted at run-time by the solver engine with portions thereof being transmittable to other devices for execution. While not shown, individual steps or groups of steps may be associated with additional information describing how the step is to be performed such as identification of data the step is to be performed on and policy information. Further, individual steps may include the specific code to be executed or may refer to additional recipes (not shown) that are to be executed by the solver engine 250 as part of executing that step. While the recipe 300 shows one example of a recipe for performing a particular function, it will be apparent that other recipes may include additional or alternative steps and flows for implementing different functions.

In this example, the recipe 300 is a recipe for performing a simulation using the controlled system twin 224. This recipe 300 may be generally useful for any components (including other recipes) that wish to perform a particular simulation (e.g., the control pathfinder 264 may invoke the recipe 300 multiple times to assess the outcome of possible control actions it may take). The recipe 300 includes two sections 310, 330 for achieving this goal. In some alternative embodiments, the two sections 310, 330 are actually embodied as two separate recipes and processing is handed over from the first recipe 310 to the second recipe 330 at the appropriate point based on, e.g., a pointer from the final step of the first recipe 310 to the first step of the second recipe 330, or a third recipe (not shown) that includes these two recipes 310, 330 as sequential steps therein.

Each of these steps 312-326, 332-346, groups thereof, or entire recipes may be outsourced through the distributed work engine 240. Many of these steps 312-326, 332-346 may specify or otherwise be associated with data against which their functions are performed, such as the digital twin (or a portion thereof) or a modified version thereof. The recipe 300 may also include various policy information associated with the steps 312-326, 332-346, groups thereof, or the recipe as a whole indicating how the various actions are to be performed (e.g., local or outsourced, effort level, completion criteria, etc.). Various steps may 312-326, 332-346 also represent more than one discrete actions and therefore can be separated into more than one individual job requests to be outsourced to other devices.

The first recipe section 310 may perform the function of estimating the current state of the digital twin. That is, the digital twin may be “warmed up” based on what is known about the state of the real-world system it models, such that an accurate simulation may be performed later. In a first step 312, the digital twin is “compiled” so it may be used. As used in the context of this step 312, compilation may not necessarily refer to conversion of source code into machine code. Instead, this step 312 may involve taking whatever steps are appropriate for to place the digital twin in form for the simulation. For example, in some embodiments, the relevant portions of the digital twin are selected (e.g., by using ontological reasoning to avoid any portions of the digital twin that are not relevant to the simulation to be performed), pulled from storage and placed in memory in form that is computable or simulable.

Next, in step 314, one or more probes may be queried based on the simulation to be performed. In various embodiments, the step of querying probes involves obtaining keypaths (or other pointers or references) to the relevant parameters of the digital twin. For example, if the simulation to be performed will involve controlling zone temperatures by adjusting the open/close position of one or more valves in a hydronic heating system, step 314 may obtain keypaths for the temperature of all relevant zones and for the controllable state of each valve in the relevant portion of the twin (as determined in step 312). These probes and cost functions constructed using the probes may then be used downstream in the recipe by the various optimizers and other steps to be described.

After step 314, the recipe splits to define two steps that may be performed in parallel. On one side, step 316 specifies that stochastic gradient descent is to be used to estimate the state of the digital twin (e.g., using a cost function derived from the probes). On the other side, step 318 specifies that a simple neural network (as may have been previously trained to perform quick state estimation) is to be used for the purposes of state estimation. At this point the flow then converges back to step 322. Various behaviors for determining when flow should proceed may be implemented, e.g., through a policy that the recipe applies to this group of steps 316, 318. Some possible policies may specify that flow will continue after the first of the two steps 316, 318 finishes (whichever it is); flow will continue after both results are received and the better result (e.g., according to some criteria or metric) will be passed on; or flow will continue after both results are received and both results will be passed on for the later steps to utilize.

In step 322, a self-organizing migration algorithm (SOMA) is used to further refine the state estimation (e.g., to ensure that a global minimum or at least a better local minimum is found if one is available). While any of the steps of the recipe 300 (or groups of steps, or the entire recipe) may be outsourced via the distributed work engine 240 to other devices, it will be appreciated that the SOMA step 322 is an example of a type of step that poses additional considerations. Because SOMA employs a multi-agent approach, this one step 322 may also be viewed as a group of steps. As one example, the SOMA step 322 may specify that n agents are to be used and may, therefore, be split into n steps for outsourcing by the distributed work engine 240. Further, since SOMA typically enables the various agents to communicate with each other, it may be a challenge to enable such communication when the agents are distributed among multiple devices. To address this, only those agents executing on the same machine may communicate with each other, or the SOMA step 322 may be phased, wherein the n agents perform SOMA among the distributed devices for some number of cycles, report results back to the DWE server, share information, and then a new set of n SOMA jobs are transmitted out to the client devices. Thus, following this approach, n agents executed over m phases would produce n×m jobs for outsourcing. Various other approaches may be followed as well. In some embodiments, the n agents may be divided among patches of multiple agents intended to execute on a single machine and, as such, share information with each other during the SOMA process. Continuing the example, if the step 322 specifies patches of j agents, the step may represent n/j jobs for distribution among the client devices. In some embodiments, the patch and phase approaches may be combined—each patch may be resent for each of the m phases or the j patches may be distributed over the m phases such that patches in later phases receive the benefit of information sharing from earlier phase patches.

At the end of the recipe section 310, a training archivist step 326 gathers at least some of the data that was generated by the steps 312-322 for the purposes of creating training data. Such training data may be used by another recipe or by an explicit training step (not shown) of the present recipe 300 to train a machine learning model, such as the neural network invoked by the neural network step 318. For example, the simulation data generated in steps 316, 322 may provide training data to create that neural network such that a lower-cost but sufficient state estimation is trained over time.

Once state estimation is complete, the next recipe portion 330 may perform the step of system simulation. A first step 332 performs SOMA again, but this time for a cost function relevant to the desired simulation. The recipe 300 then branches again, this time with three parallel steps: a stochastic gradient descent step 334, a genetic algorithm step 336, and a neural network step 338, each utilizing their own approach to optimize a cost function and produce a usable system simulation against the digital twin. An ensemble step 342 then combines the output of these three steps 334, 336, 338 to produce a unified step. A refiner step 344 may further adjust the output by, e.g., adjusting the weights applied by the ensemble step 342 to each of the three results. Again, a training archivist step 346 may gather relevant result, input, or intermediate data created by the other steps of the recipe 300. For example, this training archivist step 346 may generate training data useful for training the neural network invoked by the neural network step 338.

With regard to distributed execution of the recipe, multiple approaches may be followed. In some embodiments, the solver engine 250 may send the entire recipe 300 to another controller 292 for end-to-end execution and then receive the job result back, either as a discrete response message including data or in another form such as an update to the replicated database 226. Additionally or alternatively, the solver engine 250 may select individual steps 312-326, 332-346 to send to other controllers 292 for execution, and then return to the normal flow of the process set forth by the recipe when the job result is received back. In either of these, or in other, cases, the recipe itself may identify when to distribute individual steps, groups of steps, or the entire recipe; the solver engine 250 may make such a decision (based on local processing load; or the distributed work engine 240 may make such a decision (based on a fuller view of system health and load across all available controllers). Some instances, all work is sent to the distributed work engine 240, which may distribute all work among the remote controllers 296 and the local controller as a single pool 210. Thus, in some such embodiments, the distributed work engine 240 may at times “outsource” work to the controller's 210 own incoming work request queue.

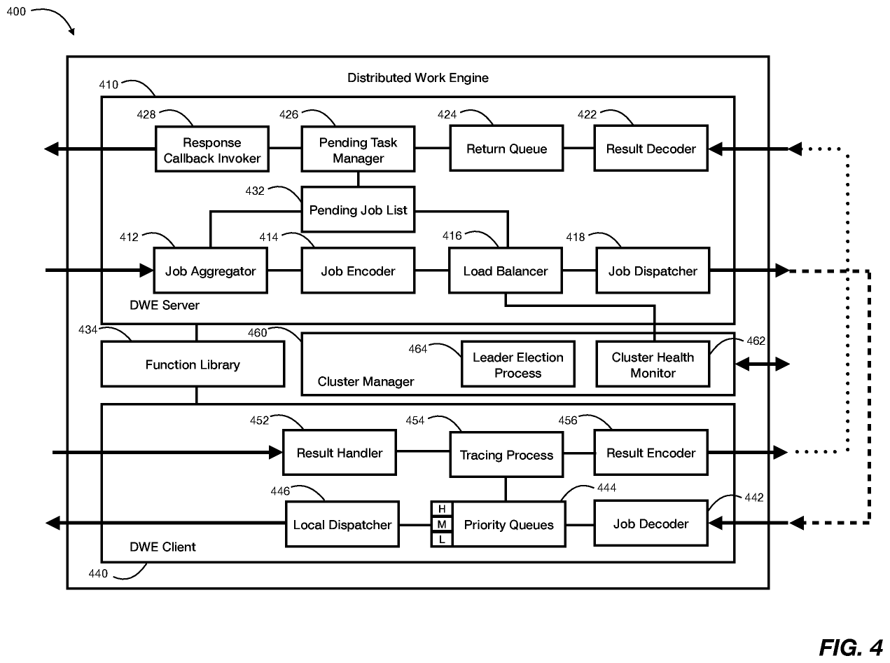

FIG. 4 illustrates an example architecture of a distributed work engine 400. This distributed work engine 400 may provide a more detailed view of the distributed work engine 240 of example controller 210. Accordingly, the distributed work engine 400 may receive jobs (or groups thereof) from other local components (such as the solver engine 250) to be outsourced to other controllers 296; and may similarly receive job requests from other controllers 296 to be executed locally and returned as results. To facilitate these functions, the distributed work engine (DWE) 400 includes a DWE server 410, a DWE client 440, and a cluster manager 460.

The DWE server 410 may be broadly responsible for handling locally originating jobs, distributing jobs among controllers 210, 296 for execution, and handling the job results as they are returned. On an outgoing path, the DWE server 410 first receives jobs at a job aggregator 412. Such receipt may be via an Application Programmer Interface (API) or other library call implemented by the job aggregator 412 and usable by the other software components of the controller 210. The job aggregator 412 determines, for a particular request from an internal component (e.g., the solver engine 250) how many jobs are to be sent for execution, what code is to be executed, what data and variations thereof will be operated on, what policy to apply for a job or group of jobs, etc. For example, when the solver engine 250 requests work to be performed, the request may actually entail a group of jobs such as a simulation of building temperature over the next 24 hours for each of the 100 most likely weather patterns to occur. Such a request would actually entail 100 different simulations of the building. When a request is for a group of more than one job, the job aggregator 412 splits the request into individual jobs to be performed.

While in some embodiments, the job requests sent to the client device(s) will specify the code to be executed by including that code in the message, in other embodiments the job requests specify the code to be executed by a mutually-understood handle between the server and clients (e.g., the DWE server 410 may pre-send each chunk of code along with corresponding handle to each DWE client 440, or each controller 210, 292 may have the code and handles pre-installed from factory install or through a software update). As such, the distributed work engine 400 includes a function library 434 that maintains a list of code chunks that can be used for performing distributed computation. In various embodiments, the function library 434 is a list of function names correlated to the code chunk to be executed. Various methods for achieving such correlation may be used such as storing the code in association with the name, storing a memory location (i.e., a reference) where the code can be located, or simply relying on the program loader as the function library 434 to locate functions known to the program or (e.g., in the case of Swift implementations) functions belonging to classes conforming to a protocol that makes those functions available for distributed work. In such implementations, the job aggregator may identify the function handle that correlates to the chunk of code that is to be executed, so that this function handle may be included in the job request(s). This technique is one manner by which the distributed work engine 400 may perform “deduplication,” and thereby reduce the amount of information that is communicated between the controllers 210, 292 for the purposes of performing distributed computations.

In some embodiments and in some cases, the job request includes particular data that is to be operated on by the chunk of code. Notably, in many cases, the chunk of code is intended to operate on or based on the digital twin 220 or a slight variation thereto. In some such embodiments and instances, the DWE server 410 may send the digital twin or other data to be used to the client device(s) that will execute the code chunk for the job. In other embodiments, the DWE server 410 may rely on the fact that the client device has access to at least some of the data already (e.g., via the replication of the database 226 across the controllers 210, 292). To account for variations to the data on which the job is to be performed, the job request(s) may simply specify the changes (i.e., “delta” values) to be made to the already-known data before execution of the code chunk. Various methods for defining delta values will be apparent such as, for example in the context of the digital twin 220, a data structure that specifies each change as an identification of a node in the graph, an identification of a behavior or property of that node, and an identification of a new value for that behavior or property. In such embodiments, the job aggregator 412 may perform this function of generating one or more deltas for the job request(s) based on the data known to the client devices (be known through data replication, through transmission of an initial establishment message carrying the data ahead of the job requests, or in some other manner). This technique is another manner by which the distributed work engine 400 may perform deduplication, and thereby reduce the amount of information that is communicated between the controllers 210, 292 for the purposes of performing distributed computations.

In some embodiments, the internal request identifies a group of jobs as a cluster of jobs related to each other. In such situations, the job aggregator 412 may simply perform a difference operation among this pre-made cluster of jobs (and associated date) to create the delta values. In other embodiments, the group of jobs may not explicitly be preclustered. In such a situation, the job aggregator 412 may perform its own clustering of jobs before computing deltas from the clusters it has created. Various clustering algorithms may be used such as affinity propagation, k-means, agglomerative clustering, etc.

After processing the internal request into one or more job requests, the job aggregator 412 may also update a pending job list 432 with information about the internal request and the job request(s) so that progress can be tracked. The pending job list 432 may include information such as an ID for the internal request (e.g., the group of job requests), a “callback” function that is to be called to inform the internal requestor when the internal request has been fulfilled, IDs for reach job request associated with the internal request, IDs for the client device chosen for each job request (as may be later selected by the Load Balancer 416), policy information for the internal request, and other information relevant to the internal request or constituent job request(s).

With respect to policy information, the internal request or constituent job request(s) may be associated with various policy information indicating how jobs are to be performed or managed. In some cases, policy information is sent as part of the job request while, in other cases, the policy information is kept locally (e.g., in the pending job list 432) for use by the DWE server. Policy may be decided or otherwise specified by the distributed work engine 400, the requesting component (e.g., the solver engine 250), or the recipe from which the work originates. Policy information may include, for example, a priority (e.g., low, medium, or high) for job execution, a timeout period after which job requests will be cancelled or resent (e.g., to a different client device), a duration or amount of processing time to be spent on the internal request or individual jobs, or an indication of how many or what proportion of jobs need to be complete before the internal request is considered fulfilled (e.g., 80% of jobs may be sufficient to send results back for use in the larger process).

After the job aggregator 412 produces one or more job requests, a job encoder 414 encodes and compresses the job request for transmission. As will be understood, various codecs and compression methods may be employed for the purpose of reducing the size of each job request and otherwise organizing each job request for transmission. Virtually any such methods may be used so long as the controllers 210, 292 agree on the methods such that communications may be understood.

A load balancer 416 may then choose one or more controllers 210, 292 to executed each job request provided to it by the job encoded 414. Virtually any method may be used for selecting which controllers will be selected. In some embodiments, the selection may be random or may use an algorithm such as round robin, weighted round robin, least connection, weighted least connection, or other load balancing algorithm. In some embodiments, the load balancing algorithm may take into account a current health, load, or other status of the controllers 210, 292 in determining which one will receive each request. For example, if the current cluster health monitor 462 indicates that a particular controller has a fault or is busy with local tasks, the load balancer may avoid or remove algorithm weight from that controller when assigning a job request. Similarly, if the pending job list 432 indicates that a particular controller has a relatively large number of outstanding job requests or has taken a relatively long time (or has timed out) on one or more job requests, the load balancer 416 may take similar actions. In contrast, if the status indicates that a controller has relatively high capacity or ability to process job requests, the load balancer 416 may add algorithm weight or otherwise increase preference for that controller. After selecting a controller for a particular job, the load balancer 416 may update the pending job list 432 with the new information and then passes the job request onto the job dispatcher 418.

The job dispatcher 418 performs the function of sending the job request to the selected client device. This may involve placing the job request into an addressed packet and frame for transmission, or the job dispatcher 418 may rely on a downstream component (e.g., a protocol stack implemented in the communication interface 212) to perform this function by simply passing the job request to that component with an identification of the intended recipient.

Turning to the client side, the DWE client 440 of the intended recipient will receive the job request (e.g., from the device's communications interface 212) at a job decoder 442. As noted above, in some embodiments, the distributed work engine 400 for a controller 210 may send job requests to remote controllers 292 or the local controller 210 itself (i.e., it may include the local controller 210 in the pool for work distribution). Each remote controller 292 may implement the same or similar distributed work engine 400 as illustrated with respect to the controller 210. For the purposes of ease of description, the DWE client 440 operations will be described with respect to the local controller 210; it will be understood however that the same description may thus apply to execution of a job request by a remote controller 292.

The job decoder 442 performs the inverse function of the job encoder 414. That is, whatever encoding and compression that the job encoder 414 is configured to perform on the job request prior to transmission, the job decoder is configured to perform the inverse decoding and decompression methods on the received job requests. Thus, virtually any codec or compression methods may be used by the job decoder 442.

After decoding and decompression, the job decoder 442 passes the received job request to an incoming request queue 444. According to some embodiments, this queue is a set of priority queues 444 that distribute incoming job requests among two or more priority queues (e.g., a high, medium, and low queue). The selection of priority may be performed by the DWE client 440 itself (e.g., based on the chunk of code involved, or based on the requestor) or may be determined by policy information contained in the received job request.

A local dispatcher 446 may then select job requests from the priority queues 444 to be processed and instruct the relevant internal controller components (e.g., the solver engine 250 or one or more step engines 260) to perform the work. Various scheduling approaches may be used to implement a multi-queue organization such as random selection, first come first served, shortest job first, longest job first, pure priority, round robin, weighted round robin, preemptive algorithms, etc. When the local dispatcher 446 selects a job request from the queue 446 it may perform some setup for the internal component to perform the work, such as retrieving the chunk of code identified by the function handle, retrieving the data to be operated on, or applying the deltas to the data to be operated on. In other embodiments, other internal controller components may be responsible for this stage setting. The local dispatcher 446 then notifies the appropriate internal component(s) (e.g., via an API or other library call) of the work that is to be performed.

Once the internal controller component(s) (e.g, the solver engine 250 or step engine 260) have finished executing the chunk of code on the data, it may send the result back to the DWE Client 440 (e.g., via an API or other library call). A result handler 452 receives the result of the computation and creates a result message to be sent back to the requesting controller's DWE server 410. The result handler 452 may thus create a result message that includes, in addition to the computation result, information such as an ID of the job request, an ID of the controller that performed the computation, and tracing data that provides trace information about the execution of the computation. In some embodiments, this information is already included in the result received by the result handler (e.g., the result may be timestamped after the completion of each step of the computation). In other embodiments, a separate tracing process 454 tracks and appends this information to the result message created by the result handler. For example, as a most basic trace, the tracing process may simply compute the difference between when the job requests was received into the priority queues 444 and when the corresponding result is being processed for transmission back to the requesting DWE server 410.

A result encoder 456 may perform a process similar to that described above with respect to the job encoder 414. Namely, the result encoder 456 may encode and compress the result message before ultimately sending the result message (e.g., via the communications interface 212) back to the requesting controller. In some embodiments, the result encoder 456 may utilize the same codecs and compression algorithms utilized by the job encoder 414 while, in others, alternative codecs and compression algorithms may be used. Again, virtually any codecs and compression algorithms may be used so long as the result decoder 422 understands to use the complementary methods so as to be able to understand the job result.

As the DWE server 410 receives the job result back from a DWE client 440 (whether on the local device or a remote device), the job result is first decompressed and decoded by the result decoder 422 which, as described above, applies the inverse methods of the job decoder 442 so as to reestablish the job result in a form that will be usable by the other components of the DWE server 410. The result decoder 422 then places the job result into a return queue 424. As shown, the return queue may be a simple first-in-first-out queue, but other arrangements may be utilized (e.g., multiple priority queues or other queue driven by the policy of the jobs and internal requests, as may be tracked by the pending job list 432).

The pending task manager 426 may perform various functions for handling job results, managing the pending requests in the pending job list 432, and implementing the policies of each internal request. With respect to received job results, the pending task manager 426 may sequentially retrieve received job results from the return queue and determine, for each, determine whether a result is ready to be returned to the internal requestor. For example, where the pending job list 432 indicates that the internal request is associated with only a single job request, the pending task manager 426 can then pass that job result forward as soon as it is received and remove the internal request from the pending job list 432. As another example, where the pending job list 432 indicates that the internal request is associated with multiple job requests, to which the current result corresponds to one, the pending task manager 426 may determine whether a sufficient number of results have now been received (e.g., per the policy noted in the pending job list 432, the sufficient number could be all jobs, 80% of jobs, 10 jobs, etc.). If not, the pending task manager 426 may store the job result or the relevant portion thereof (e.g., in the pending job list 432) for future delivery to the internal requestor with the rest of the relevant job results for that internal request. Various alternative arrangements will be apparent. For example, in some embodiments, rather than aggregating results for a multi-job request, the pending task manager 432 may simply send along each job request as it is receive, even if more job results are expected for the internal request.

The pending task manager 426 may also manage the internal requests and pending job requests outside the context of a received job result. For example, job requests may include a timeout period that the pending task manager 426 tracks. If a job request times out, the pending task manager 426 may take different actions which may be based on the policy for the internal request. The pending task manager 426 may, as an example, cause the job request to be retransmitted the originally assigned client device, cause the job request to be assigned and transmitted to a new client device, send a job cancellation notification to the originally assigned client device, or remove the job request from the internal request entirely or otherwise ignore the missing job result (so as to proceed with those job results that are actually received). As another example, the pending task manager 426 may track a time to live for the entire internal request and, upon expiration, pass along all of those results actually received and cancel the rest.

After the pending task manager 426 passes on one or more job results, the response callback invoker 428 may invoke the callback function for the internal requestor, so as to deliver the results of the request (e.g., the data from each job response). The callback function may be a static function for each particular internal component (e.g., the solver engine 250 may have a single callback function to be used for all internal request results) or may be specified by the internal requestor at the time of making the request (e.g., the solver engine 250 may specify a particular function be called for a particular internal request). Upon invoking the callback function, control of the larger process is returned to the requestor or the requestor is otherwise informed that it may continue with execution of the larger process that spun off the internal request.

As previously described, the distributed work engine 400 may also manage the compute cluster formed by the controllers 210, 292 and, as such, includes a cluster manager to coordinate these functions. A cluster health monitor 462 tracks the status, load, or other health metrics for the controllers 210, 292 to better inform the distributed computation decisions that will be made. Various methods for gathering this information will be apparent. For example, the cluster health monitor 462 may track the turnaround time for job requests issued by the DWE server 410; may be notified when a job response is not received, reassigned, or canceled by the pending task manager 426; may evaluate trace data received in a job result; may receive notification that communication was lost or otherwise unsuccessful with a particular controller 210, 292; may receive notifications from controllers 210, 292 of errors, faults, or other status updates; or may periodically attempt communication with controllers 210, 292 to check connection status or ask for a report of various system status metrics.

A leader election process 464 may coordinate with other controllers 210, 292 to elect one or more controllers to act as a leader for the cluster. The leader election process 464 may run when there is not a leader set (e.g., on initial system start or after a restart); on a periodic basis; at the expiration of a timer; in response to a manual trigger; or in response to an indication from the cluster health monitor 462 that a new leader should be elected. The cluster health monitor 462 may decide to make such an indication when, for example, communication is lost with a previously-elected leader; a fault, current load, or other status indicates that a previously-elected leader may not be optimal to perform the role currently; or a previously-elected leader has sent a message requesting to not be a leader anymore. The leader election process 464 may use virtually any known method for electing one or more leaders such as, for example, each controller 210, 292 randomly voting for a leader; selecting the controller 210, 292 with the most votes if any; removing the controller(s) 210, 292 with the least votes; and repeating until a leader is elected. Various other methods will be apparent, including election methods that take into account each controller's 210, 292 status gathered by the cluster health monitor 462 so as to favor those controllers 210, 292 best or better suited to performing the role. After election is complete, the leader election process 464 indicates to the rest of the controller 210 components whether the controller 210 should operate as a leader or follower (e.g., by writing a value to a system-wide variable).

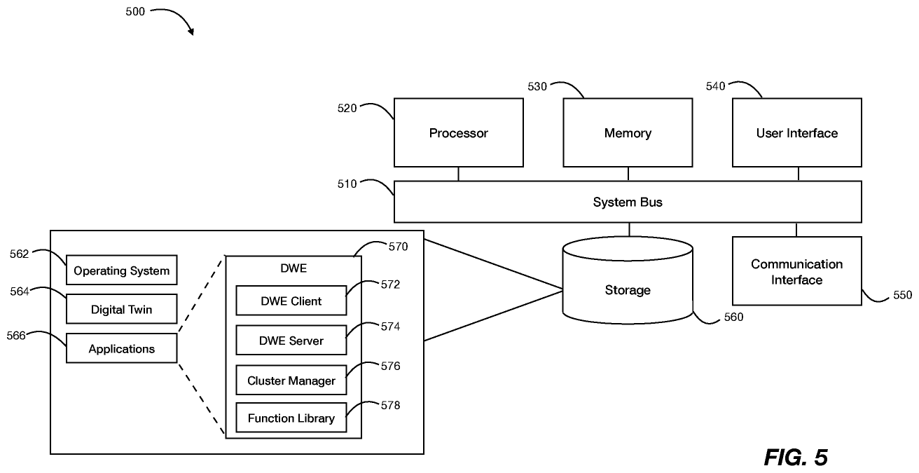

FIG. 5 illustrates an example hardware device 500 for implementing a controller, server, or other device for defining or utilizing a digital twin. The hardware device 500 may describe the hardware architecture and some stored software of one or more of the controllers 132-138, 210 previously described or may describe the hardware of another device implementing some or all of the functionality described herein such as, for example, enabling distributed computation of portions of a larger process. As shown, the device 500 includes a processor 520, memory 530, user interface 540, communication interface 550, and storage 560 interconnected via one or more system buses 510. It will be understood that FIG. 5 constitutes, in some respects, an abstraction and that the actual organization of the components of the device 500 may be more complex than illustrated.

The processor 520 may be any hardware device capable of executing instructions stored in memory 530 or storage 560 or otherwise processing data. As such, the processor 820 may include a microprocessor, field programmable gate array (FPGA), application-specific integrated circuit (ASIC), or other similar devices.

The memory 530 may include various memories such as, for example L1, L2, or L3 cache or system memory. As such, the memory 530 may include static random access memory (SRAM), dynamic RAM (DRAM), flash memory, read only memory (ROM), or other similar memory devices. It will be apparent that, in embodiments where the processor includes one or more ASICs (or other processing devices) that implement one or more of the functions described herein in hardware, the software described as corresponding to such functionality in other embodiments may be omitted.

The user interface 540 may include one or more devices for enabling communication with a user such as an administrator. For example, the user interface 540 may include a display, a mouse, a keyboard for receiving user commands, or a touchscreen. In some embodiments, the user interface 540 may include a command line interface or graphical user interface that may be presented to a remote terminal via the communication interface 550 (e.g., as a website served via a web server).

The communication interface 550 may include one or more devices for enabling communication with other hardware devices. For example, the communication interface 550 may include a network interface card (NIC) configured to communicate according to the Ethernet protocol. Additionally, the communication interface 550 may implement a TCP/IP stack for communication according to the TCP/IP protocols. In devices 500 that operate as a device controller, the communications interface 550 may additionally include one or more direct wired connections to such controlled devices or connections to separate I/O modules (not shown) providing such connections. In applications where the device 500 is deployed in the context of an HVAC system, the communications interface may communicate according to an appropriate protocol such as BACnet. Various alternative or additional hardware or configurations for the communication interface 550 will be apparent.

The storage 560 may include one or more machine-readable storage media such as read-only memory (ROM), random-access memory (RAM), magnetic disk storage media, optical storage media, flash-memory devices, or similar storage media. In various embodiments, the storage 560 may store instructions for execution by the processor 520 or data upon with the processor 520 may operate. For example, the storage 560 may store a base operating system 562 for controlling various basic operations of the hardware 500.

The storage 560 additionally includes a digital twin 564, such as a digital twin according to any the embodiments described herein. As such, in various embodiments, the digital twin 564 includes a heterogeneous and omnidirectional neural network. The storage also includes one or more applications 5866 that may make use of the digital twin 564. For example, the applications 566 may include an application for controlling a system of HVAC equipment, an application for providing a user interface of current and predicted state, an application for allowing a user to run simulations against one or more hypotheses, an application for assisting product design with simulation and other digital twin-derived insights, or any other application that may make use of a digital twin 564. Thus, in some embodiments, the applications 566 may correspond to one or more components of the controller 210 such as the solver engine 250 or semantic translator 232. In some embodiments, some or all of the applications 566 may not be coresident in the storage 560 with the digital twin 564 and, instead, may be run on other systems that access the digital twin 564 as needed with remote calls, e.g., via the communications interface 550 and an application programmer interface (API) (not shown).

The applications 566 include a distributed work engine 570 that is usable by at least some of the other applications 566 to distribute jobs for execution by other devices (such as other devices implemented according to the hardware arrangement 500). Thus, the distributed work engine 570 may correspond to distributed work engine 240 or distributed work engine 400, as previously described. Further, the distributed work engine 570 includes a DWE client 572 (e.g., corresponding to the DWE client 440), a DWE server (e.g., corresponding to the DWE server 440), a cluster manager 576 (e.g., corresponding to the cluster manager 460), and a function library 578 (e.g., corresponding to the function library 434). These sub-elements 572-578 may include instructions or data, respectively, for implementing the functionality described above with respect to the corresponding elements of the DWE 400. Example methods for implementing at least some of this functionality will be described with reference to FIGS. 10-13.

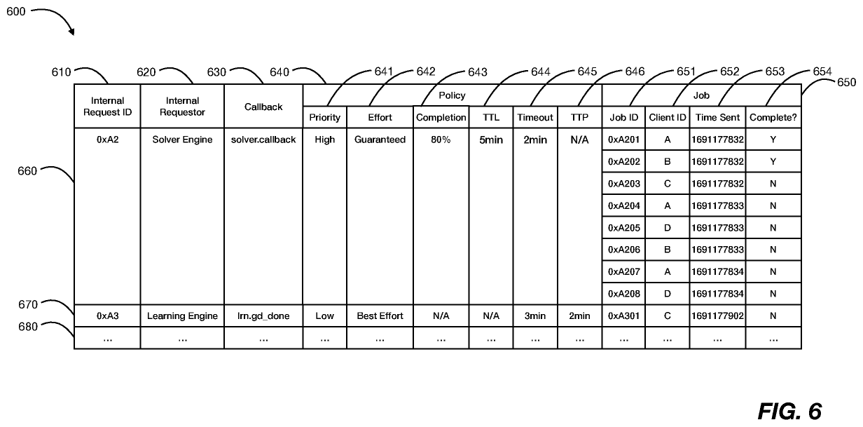

FIG. 6 illustrates an example data arrangement 600 for implementing a pending job list. The data arrangement may correspond to the pending job list 432 as previously described and, as such, may track various information related to internal requests and their one or more constituent jobs. It will be apparent that various data structures may be used to implement the data arrangement such as, for example, one or more tables, objects, arrays, linked lists, trees, and hash tables. As shown, the data arrangement includes an internal request ID field 610, an internal requestor field 620, a callback function field 630, a set of policy fields 640, and a set of job fields 650. It will be understood that, while particular data types (e.g., sequential hexadecimal codes, human-readable text, etc.) are shown as example data for the various fields 610-650, various implementations may utilize virtually any data types useful for storing the various information.

The internal request ID field 610 may store some identifier for tracking each internal request. This value may be assigned (e.g., sequentially) by the distributed work engine 240 upon receipt of a request for distributed work from an internal component. The internal requestor field 620 may store in identification of or reference to the internal component that has requested the performance of distributed work. The callback field 630 may store an identification of or reference to the function that should be called to indicate to the requestor that the request for distributed work has been completed and that it can continue processing the larger process. As shown, the callback method may be a method implemented by the requestor itself; in such embodiments, the requestor ID field 620 could be omitted. In other embodiments, a single callback function may be implemented that receives the requestor ID as a parameter and then directs the response appropriately.

A policy field 640 includes multiple possible sub-fields including, for example a priority field 641, an effort field 642, a completion field 643, a time-to-live field 644, a timeout field 645, and a time-to-process field 646. The priority field 641 may indicate with which priority client devices will process the jobs from the internal request (e.g., what priority queue 444 the jobs requests should be placed in). The effort field 642 may indicate what level of effort the DWE server 410 should expend to ensure job requests are served (e.g., best efforts or guaranteed efforts). The completion field 643 may indicate one or more metrics for determining that the received responses are sufficient to consider the internal request complete. The time-to-live field 644 may store a duration that the internal request should be pending, after which it will be completed (if not already) or canceled. A timeout field 645 may store a duration that each job should be completed within an after which it will be considered timed out such that the pending task manager 426 may take remedial action based on the rest of the policy (e.g., the effort field 642). The time-to-process field 646 may store a duration for which client devices should process each job, after which results will be returned (e.g., where particular job results could be refined indefinitely but where diminishing returns or “good enough” may reached after a known time). Various alternative or additional policy sub-fields may be implemented for different policy controls to those described here.

The jobs field 650 may store a listing of the job requests (or job results, after receipt) associated with a particular internal request. As shown, the job field 650 includes multiple possible sub-fields further describing the job(s) such as a job ID field 651, a client ID field 652, a time sent field 653, and a completion field 654. The job ID field 651 may store a unique identifier for each job. The client ID field 652 may store an identifier of the client device or DWE client chosen to process the job. The time sent field 653 may store an identifier of a time that the job request was sent to the client device (e.g., for the purpose of tracking job timeouts). A completion field 654 may store an indication of whether a job has been completed and a job result received by the DWE server. Various alternative or additional job sub-fields may be implemented for tracking aspects of the jobs different to those described here.

As a first example, the data arrangement 600 includes a first internal request record 660. This internal request was received from the Solver Engine and has been assigned an ID of “0×A2.” When the request has been completed, the DWE will call the function solver.callback to return the resulting data to the Solver Engine. Policy-wise, the request will be served with high priority and guaranteed effort (i.e., the DWE will take steps to ensure that job requests are received by the intended client device or that when job requests time out they are resent or reassigned). The request will be considered complete when 80% of results from job requests are received or after 5 minutes have elapsed. Job requests will be considered timed-out if no result is received within 2 minutes of job request transmission, but there is no time limit to be communicated to the client devices as to how long the processing should take them. The internal request is associated with 10 different job requests, 0×A201-08, that have been distributed among clients A, B, C, and D. At present, two of these jobs, 0×A201 AND 0×A202, have been completed.

As a second example, the data arrangement 600 includes a second internal request record 670. This job was received from the Learning Engine and assigned an ID of “0×A3.” Upon completion, the DWE will call the function lm.gd_done to pass the result back to the Learning Engine. The policy indicates that the priority is low and to be served with best effort. No completion criteria is specified, so a default policy of 100% completion regardless of time spent may be applied. A timeout of 3 minutes is set, and the client device will be instructed to spend 3 minutes on the task and then return whatever the current result is in at that time (even if further processing could further refine the result). The request is associated with a single job request, 0×A301, which has been transmitted to client C and is currently pending. The data arrangement 600 may include numerous additional internal request records 680.

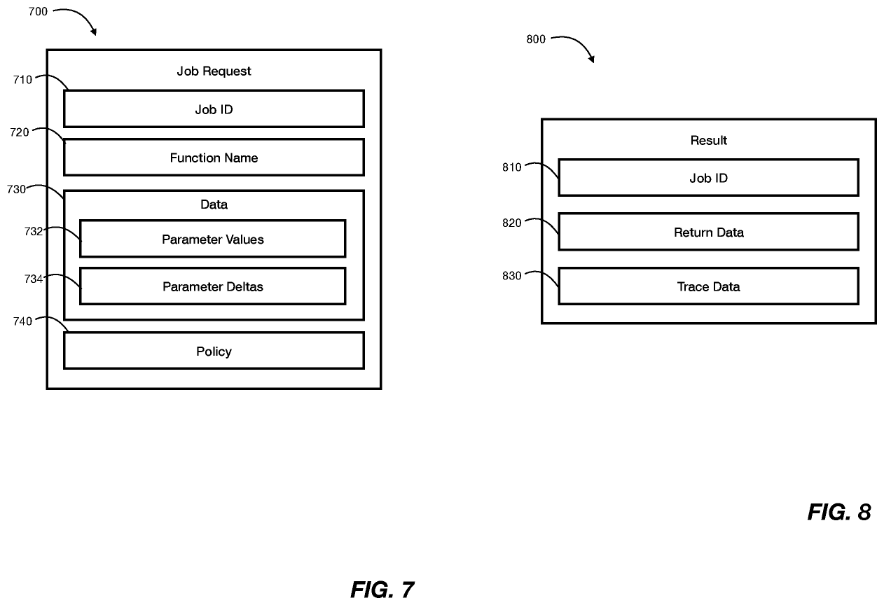

FIG. 7 illustrates an example of a job request message 700. The job request message 700 may correspond to the messages previously described as being transmitted by the DWE server 410 to the DWE client 440. The job request message 700 may be a simplification in some respects and alternative arrangements may be used. For example, in some embodiments, the job request message 700 is organized as a JSON object encapsulated in a TCP/IP packet and an Ethernet frame. Various other arrangements will be apparent.

The job request message 700 includes a job ID field 710 for identifying the job between the DWE client and DWE server. The information carried in the job ID field 710 corresponds to the ID stored in the job ID field 651 of the pending task list 600. A function name 720 field stores an identifier (name or otherwise) of the function that is to be executed by the client device. The value carried by the function name field enables the DWE client 440 to locate the appropriate chunk of code for execution from the function library 434. The data field 730 includes the data or other method of identifying the data that the identified function is to operate on. For example, in some cases, at least some of the data to be operated on is carried in full in the parameter values field 732. In some cases, at least some of the data to be operated on is carried as a delta value in the parameter deltas field 734 that is to be applied to some data already known to the client device. For example, the DWE server 410 may have previously transmitted the data to which the deltas are to be applied, such as in the case of an establishment message transmitted to the client device to be used for all job requests associated with a particular internal request or other clustering of jobs. As another example, the deltas may indicate that they should be applied to data that is already available to the client device through other processes, such as a digital twin or other data that may be replicated across all devices through normal controller operation, or data that the client device is capable of retrieving, e.g., via a web server. A policy field 740 stored information specifying those aspects of the policy for the internal request that are applicable to the execution of a job request or that may otherwise be useful to provide to the client device. For example, the policy field 740 may include priority and time-to-process information, corresponding to the information stored in the priority field 641 and TTP field 646 of the example pending task list 600. Various additional or alternative information useful for inclusion in a job request message 700 will be apparent.

FIG. 8 illustrates an example of a job response message 800. The job response message 800 may correspond to the messages previously described as being transmitted by the DWE client 440 to the DWE server 410. The job response message 800 may be a simplification in some respects and alternative arrangements may be used. For example, in some embodiments, the job response message 800 is organized as a JSON object encapsulated in a TCP/IP packet and an Ethernet frame. Various other arrangements will be apparent.

The job result message 800 includes a job ID field 810 for identifying the job between the DWE client and DWE server. The information carried in the job ID field 810 corresponds to the ID stored in the job ID field 651 of the pending task list 600 and in the job ID field 710 of the job request message 700 to which the job result message 800 responds. A return data field 820 stores the result data resulting from the computation requested by the corresponding job request message 700 in some form usable by the requesting device. For example the return data field 820 may include the literal data resulting from the computation, delta values that the requestor can apply to data known to it (e.g., through a result establishment message, already stored through data replication, or accessible from another source), an indication that the information is now available through other channels (e.g., already stored through data replication, or accessible from another source), or a simple indication that the computation has been completed successfully (or unsuccessfully with or without an error code). A trace data field 830 includes trace data for sharing with the server information about the performance of the client device in executing the job request. This information may be used by the cluster health monitor 462, load balancer 416, or other components in informing the performance of their roles. Various additional or alternative information useful for inclusion in a job request message 700 will be apparent.

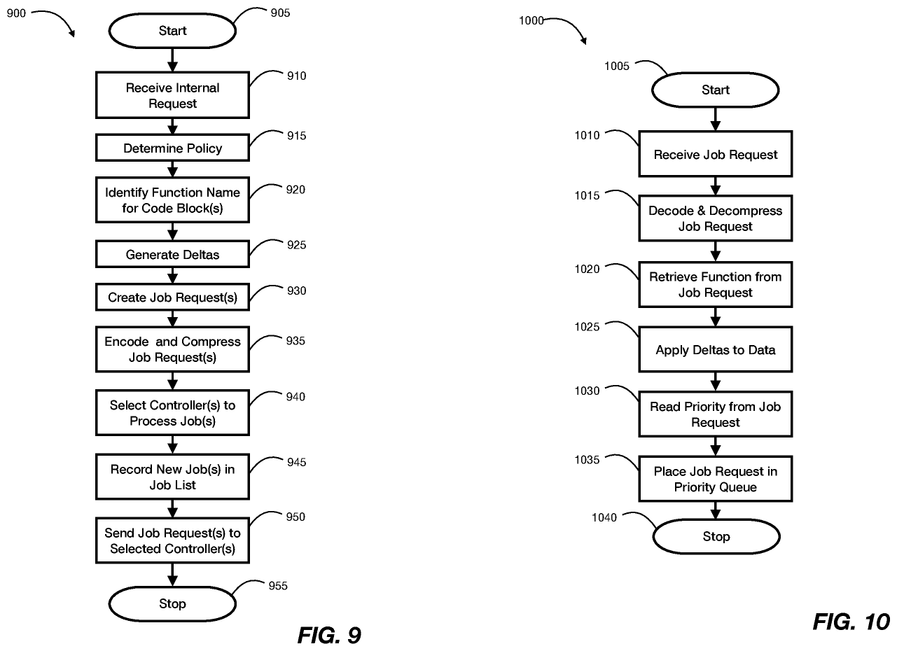

FIG. 9 illustrates an example method 900 for handling internal distributed work requests and distributing associated job requests. The method 900 may correspond to various functions performed by the DWE server 410, 574 such as those functions described as being performed by the job aggregator 412, job encoder 414, load balancer 416, or job dispatcher 418. It will be apparent that various steps may be performed in different order than described.

The method 900 begins in step 905, e.g., in response to a library call by another internal component, and proceeds to step 910 where the DWE server 410, 574 receives the internal request information from that internal component. Such internal request information may include one or more code blocks (or function names associated therewith), a number of jobs requested, specification of data and variations thereof to be operated on, or policy requirements. In step 915, the DWE server 410, 574 determines the policy that will be applied to the internal request based on, e.g., the internal device's specified policy for its request, internal DWE settings, policy associated with the internal component itself, or the current load on the DWE and other client devices.

In step 920, the DWE server 410, 574 identifies the function name that will be used to communicate the code block to the client devices. In some embodiments, the internal request received in step 910 may already specify this name. In other embodiments, the DWE server 410, 574 may refer to its function library 434 to identify the name associated with a code block or other identified received in step 910. In some embodiments, where the code block is not already known to the function library, the DWE server 410, 574 may add the code block in association with a new function name to the function library 434 and communicate the name and code block to the appropriate DWE clients (e.g., via an establishment message instructing them to update their own function libraries or via data replication to those devices).

In step 930, the DWE server 410, 574 generates the delta values for the data to be sent in the job request(s). For example, where the internal request received in step 910 indicates a desire for 100 jobs with half degree variations in weather data, the DWE server 410, 574 may generate these 100 deltas to the weather data. Next, in step 930, the DWE server 410, 574 generates the job request messages from the data identified in steps 915-925 and, in step 935, encodes and compresses these job request messages.

The DWE server 410, 574 load balances the job requests using the relevant information available to it in step 940 and selects a controller to be assigned each job request. Each job is then recorded in the pending job list 432 in step 945 in association with the internal request, and the job requests are sent to the assigned DWE clients in step 950. The method 900 then proceeds to end in step 955.

FIG. 10 illustrates an example method 1000 for receiving and enqueuing a job request. The method 1000 may correspond to various functions performed by the DWE client 440, 572 such as those functions described as being performed by the job decoder 446, priority queues 444, or local dispatcher 446. It will be apparent that various steps may be performed in different order than described.

The method 1000 begins in step 1005, e.g., in response to a message arriving for the DWE client 440, 572, and proceeds to step 1010 where the job request is received. In step 1015, the DWE client 440, 572 decodes and decompresses the job request 1015. In step 1020 the DWE client 440, 572 reads the job function from the job request and may verify that the function library 434 stores a code block for the named function. In step 1025, the DWE client 440, 572 reads any deltas from the job request and applies them to the relevant data (e.g., the digital twin) to properly stage the data for job execution. In some embodiments, this step may involve creating a copy of the data for this delta modification so that the original data is left unchanged for use in other operations. In step 1030, the DWE client 440, 572 reads the priority from the job request (if any), and, in step 1035, places the job request in the appropriate priority queue. The method 1000 then proceeds to end in step 1040. As will be understood, the method 1000 performs some amount of “unpacking” of the job request prior to enqueuing it for future execution. For example, the version of the job request placed in the priority queue may be the code block retrieved from the function library 434 in association with the modified data, such that the code and data can be sent directly to an internal component for execution. In other embodiments, the job request as decoded and uncompressed may be placed in the queue, and the functions of steps 1020, 1025 may be saved for after the job request is removed from the queue (e.g., to be performed as part of method 1100).

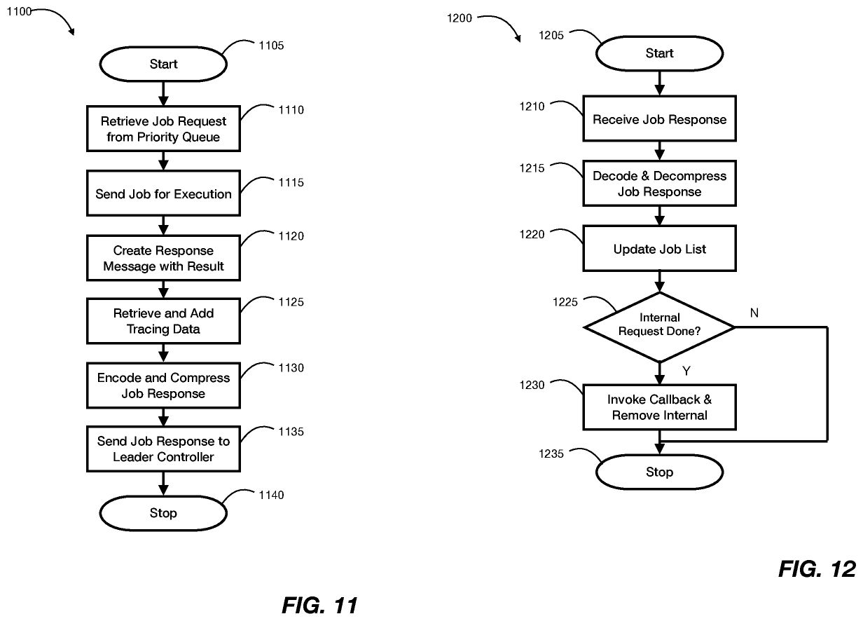

FIG. 11 illustrates an example method 1100 for executing and responding to a distributed job request. The method 1100 may correspond to various functions performed by the DWE client 440, 572 such as those functions described as being performed by the local dispatcher 446, result handler 452, tracing process 454, or result encoder 456. It will be apparent that various steps may be performed in different order than described.

The method 1100 begins in step 1105 in response to, e.g., a timer or determination by another process that the controller has capacity to process a distributed job. The method 1100 proceeds to step 1110 where the DWE client 440, 572 retrieves a job request from the priority queue according to some scheduling paradigm. In step 1115, the DWE client 440, 572 sends the job for execution. In some embodiments, the job is simply executed by calling the function or passing the code block to a processor. In some embodiments, the job is executed by a call to another internal component such as the solver engine 250, by which the code block and data is identified to that component.

When the execution is complete, and the DWE client 440, 572 receives a result back, the method 1100 proceeds to step 1120. It will be apparent that, in some embodiments, a separate method may be invoked when the job processing is complete. In other words, steps 1110, 1115 may belong to one method that ends after the job is dispatched, while steps 1120-1135 may belong to a different method that begins in response to an indication from the internal executing component that work has been completed. In any event, in step 1120, the DWE client 440, 572 begins to construct the job response message by copying the job request ID over and inserting the result of the job computation. In step 1125, the DWE client 440, 572 retrieves and inserts any tracing data that has been gathered during execution of the job. In step 1130, the DWE client 440, 572 encodes and compresses the job response and, in step 1135, sends the job back to the DWE server that send the job request (typically the leader controller, but in some embodiments, other controllers may request distributed work). The method 1100 then proceeds to end in step 1140.

FIG. 12 illustrates an example method 1200 for processing a job result. The method 1200 may correspond to various functions performed by the DWE server 410, 574 such as those functions described as being performed by the result decoder 422, return queue 424, pending task manager 426, or response callback invoker 428. It will be apparent that various steps may be performed in different order than described.

The method begins in step 1205, e.g., in response to receiving a message for the DWE server 410, 574. In step 1010, the DWE server 410, 574 receives the job response and, in step 1215, decodes and decompresses the job response. The method 1200 proceeds to step 1220 where the DWE server 410, 574 updates the pending job list 432, 600 to reflect the job completion. For example, the DWE server 410, 574 may set the value of the job complete field 654 associated with the appropriate job ID. After updating the pending job list 432, 600, the DWE server 410, 574 may determine if the internal request is now complete in step 1225. For example, the DWE server 410, 574 may determine whether one or more completion criteria (e.g., as may be stored in fields 643, 644) are now fulfilled. If not, the DWE server 410, 574 will wait for further job responses and the method 1200 will proceed to end in step 1235. If, on the other hand, the internal request is complete, the DWE server 410, 574 will, in step 1230, invoke the appropriate callback function to make the results available to the internal requestor so that the requestor component can continue with execution of the larger process (including potentially further requests for performance of additional distributed work). The DWE server 410, 574 may also remove the internal request record along with all associated job requests from the pending job list 432, 600. The method 1200 then proceeds to end in step 1235.

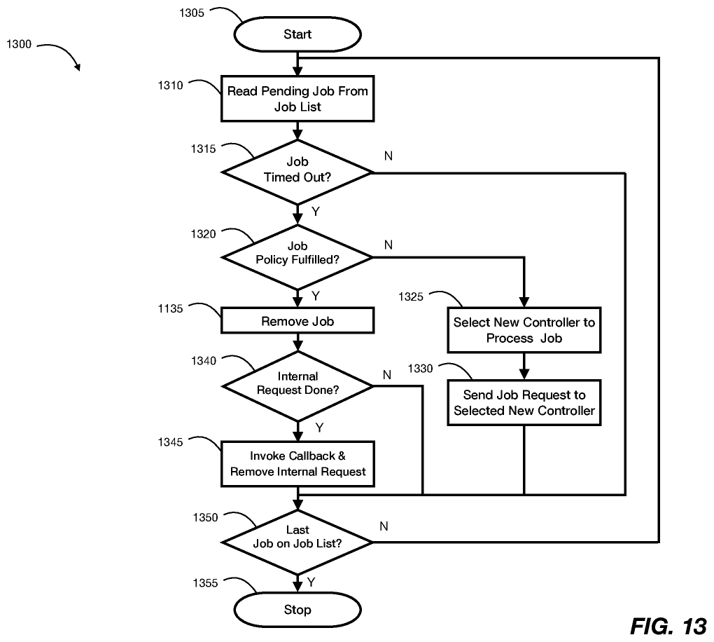

FIG. 13 illustrates an example method 1300 for auditing a pending job list. The method 1300 may correspond to various functions performed by the DWE server 410, 574 such as those functions described as being performed by the pending task manager 426. It will be apparent that various steps may be performed in different order than described.

The method 1300 may begin in step 1305, e.g., in response to the expiration of a timer such that the method 1300 runs on a periodic basis. The DWE server 410, 574 begins to iterate through the pending job list 432, 600 in step 1310 by retrieving an incomplete job to assess (e.g., as may be indicated by the job complete field 654). In step 1315 the DWE server 410, 574 determines whether the job has timed out by, for example, comparing the value in timeout field 645 to the difference between the value in the time sent field 653 and the current time. If the job has not yet timed out, the method 1300 jumps ahead to step 1350 where, if additional pending jobs remain, the method will loop back to step 1310 and continue iterating through the list.

Otherwise, the DWE server 410, 574 determines in step 1320 whether, despite the timeout, the policy for the job or internal request has been fulfilled. For example, where the effort field 642 indicates “best efforts,” the policy may be fulfilled whereas if the effort field 642 indicates “guaranteed,” policy may dictate that the DWE server 410, 574 continue trying to get the job performed. Where the policy has not been fulfilled, the DWE server 410, 574 may select a new client device to process the job request and, in step 1330, send the job request to the new client device. The DWE server 410, 574 may also, at this time, update the job record with the new client device and transmission time. The method then proceeds to step 1350.

If, on the other hand, the job policy is fulfilled despite a timed-out request, the method 1300 proceeds to step 1345 where the DWE server 410, 574 removes the job from the pending job list 432. In step 1340, the DWE server 410, 574 may determine if the internal request is now complete. For example, the DWE server 410, 574 may determine whether one or more completion criteria (e.g., as may be stored in fields 643, 644) are now fulfilled. If not, the DWE server 410, 574 jumps ahead to step 1350. If, on the other hand, the internal request is complete, the DWE server 410, 574 will, in step 1345, invoke the appropriate callback function to make the results available to the internal requestor so that the requestor component can continue with execution of the larger process (including potentially further requests for performance of additional distributed work). The DWE server 410, 574 may also remove the internal request record along with all associated job requests from the pending job list 432, 600. In step 1350, the DWE server 410, 574 determines whether the pending job list 432, 600 includes additional unfinished job records for audit. If so, the method 1300 loops back to step 1310 to continue iterating through the outstanding jobs. Once the DWE server 410, 574 has audited the list of pending jobs to be audited (e.g., all pending jobs, all jobs older than a particular time, etc.), the method proceeds to end in step 1355.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a mobile device, a tablet, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

We claim:

1. A method for performing a distributed computation comprising:
identifying a chunk of computer code from a larger process to be executed as a distributed computation;
creating a job request specifying the chunk of computer code and data on which the chunk of computer code is to operate;
selecting a device from a plurality of devices to process the job request;
transmitting the job request to the selected device;
receiving a job result from the selected device; and
continuing the larger process based on the job result.

2. The method of claim 1, wherein the job request specifies the chunk of computer code with a function name known to the selected device as being associated with the chunk of computer code.

3. The method of claim 1, further comprising receiving a request to execute a group of jobs as a distributed computation, wherein:
the group of jobs are associated with the chunk of computer code and respective variations on the data;
creating the job request comprises creating a plurality of job requests specifying the chunk of computer code and the respective variations on the data;
selecting a device comprises selecting one or more devices from the plurality of devices to process respective ones of the plurality of job requests; and
transmitting the job request comprises transmitting the plurality of job requests to respective ones of the one or more selected devices.

4. The method of claim 3, wherein:
receiving a job result comprises receiving a plurality of job results that are fewer than the plurality of job requests, and
continuing the larger process based on the job result comprises determining, based on a policy for the group of jobs, that the plurality of job results are sufficient to continue the larger process.

5. The method of claim 3, wherein:
receiving a job result comprises receiving a plurality of job results, and
continuing the larger process based on the job result comprises:
determining, based on a policy for the group of jobs, a time limit, and
when the time limit is reached, continuing the larger process with the plurality of job results received before the time limit was reached.

6. The method of claim 1, wherein the data comprises a delta value describing a change to data already known to the selected device.

7. The method of claim 6, wherein the data already known to the selected device comprises a digital twin of a real-world system.

8. A device capable of utilizing a distributed computation method comprising:
a communications interface;
a memory storing:
code specifying a process to be executed at least in part by the device; and
a processor configured to:
identify a chunk of the computer code to be executed as a distributed computation,
create job request specifying the chunk of computer code and data on which the chunk of computer code is to operate,
select a device from a plurality of devices to process the job request,
transmit the job request to the selected device,
receive a job result from the selected device, and
continue the process based on the job result.

9. The device of claim 8, wherein the job request specifies the chunk of computer code with a function name known to the selected device as being associated with the chunk of computer code.

10. The device of claim 8, wherein the processor is further configured to receive a request to execute a group of jobs as a distributed computation, wherein:
the group of jobs are associated with the chunk of computer code and respective variations on the data;
in creating the job request , the processor is configured to create a plurality of job requests specifying the chunk of computer code and the respective variations on the data;
in selecting a device, the processor is configured to select one or more devices from the plurality of devices to process respective ones of the plurality of job requests; and
in transmitting the job request, the processor is configured to transmit the plurality of job requests to respective ones of the one or more selected devices.

11. The device of claim 10, wherein:
in receiving a job result, the processor is configured to receive a plurality of job results that are fewer than the plurality of job requests, and
in continuing the process based on the job result, the processor is configured to determine, based on a policy for the group of jobs, that the plurality of job results are sufficient to continue the larger process.

12. The device of claim 10, wherein:
in receiving a job result, the processor is configured to receive a plurality of job results, and
in continuing the process based on the job result the processor is configured to:
determine, based on a policy for the group of jobs, a time limit, and
when the time limit is reached, continue the process with the plurality of job results received before the time limit was reached.

13. The device of claim 8, wherein the data comprises a delta value describing a change to data already known to the selected device.

14. The device of claim 8, wherein the data already known to the selected device comprises a digital twin of a real-world system.

15. A non-transitory machine-readable storage medium encoded with instructions for performing a distributed computation comprising:
instructions for identifying a chunk of computer code from a larger process to be executed as a distributed computation;
instructions for creating a job request specifying the chunk of computer code and data on which the chunk of computer code is to operate;
instructions for selecting a device from a plurality of devices to process the job request;
instructions for transmitting the job request to the selected device;
instructions for receiving a job result from the selected device; and
instructions for continuing the larger process based on the job result.

16. The non-transitory machine-readable storage medium of claim 15, wherein the job request specifies the chunk of computer code with a function name known to the selected device as being associated with the chunk of computer code.

17. The non-transitory machine-readable storage medium of claim 15, further comprising instructions for receiving a request to execute a group of jobs as a distributed computation, wherein:
the group of jobs are associated with the chunk of computer code and respective variations on the data;
the instructions for creating the job request comprise instructions for creating a plurality of job requests specifying the chunk of computer code and the respective variations on the data;
the instructions for selecting a device comprise instructions for selecting one or more devices from the plurality of devices to process respective ones of the plurality of job requests; and
the instructions for transmitting the job request comprise instructions for transmitting the plurality of job requests to respective ones of the one or more selected devices.

18. The non-transitory machine-readable storage medium of claim 17, wherein:
the instructions for receiving a job result comprise instructions for receiving a plurality of job results that are fewer than the plurality of job requests, and
the instructions for continuing the larger process based on the job result comprise instructions for determining, based on a policy for the group of jobs, that the plurality of job results are sufficient to continue the larger process.

19. The non-transitory machine-readable storage medium of claim 17, wherein:
the instructions for receiving a job result comprise instructions for receiving a plurality of job results, and
the instructions for continuing the larger process based on the job result comprise:
instructions for determining, based on a policy for the group of jobs, a time limit, and
instructions for, when the time limit is reached, continuing the larger process with the plurality of job results received before the time limit was reached.

20. The non-transitory machine-readable storage medium of claim 15, wherein the data comprises a delta value describing a change to a digital twin of a real-world system.
